(19) United States
(12) Patent Application Publication
(10) Pub. No.: US 2026/0352125 A1
(43) Pub. Date: Nov. 5, 2026

(54) DIELECTRIC ELASTOMER ACTUATOR, TRANSDUCER, APPARATUS, INFORMATION PROCESSING SYSTEM, AND METHOD FOR MANUFACTURING DIELECTRIC ELASTOMER ACTUATOR

(71) Applicant: SONY GROUP CORPORATION, TOKYO (JP)

(72) Inventors: DAISUKE YAMAMOTO, TOKYO (JP); YUSAKU KATO, TOKYO (JP); RYO IWAMURO, TOKYO (JP); TAKAHITO SUZUKI, TOKYO (JP); YOSHIO GOTO, TOKYO (JP)

(21) Appl. No.: 19/115,532

(22) PCT Filed: Sep. 25, 2023
(86) PCT No.: PCT/JP2023/034682

§ 371 Date: Mar. 26, 2025

(30) Foreign Application Priority Data
Oct. 3, 2022 (JP) 2022-159674

(51) Int. Cl. H02N 11/00

(52) U.S. Cl. CPC H02N 11/00

(57) ABSTRACT

It is an object of the present disclosure to provide a new method for manufacturing a small rDEA. Further, it is also an object of the present disclosure to provide a small rDEA.

The present disclosure provides a method for manufacturing a rolled dielectric elastomer actuator, the method including a rolling step to roll at least one pair of complimentary electrode layers and a dielectric elastomer layer around a core to obtain a rolled body, a change step to change a state of the core after the rolling step, and a removal step to remove the core from the rolled body after the change step. Further, the present disclosure also provides a dielectric elastomer actuator that includes a rolled body of a laminate including at least one pair of complimentary electrode layers and a dielectric elastomer layer, the laminate having a thickness of 200 μm or less.

### TECHNICAL FIELD

The present disclosure relates to a dielectric elastomer actuator, an apparatus that includes the actuator, and an information processing system that includes the apparatus. Further, the present disclosure relates to a method for manufacturing the dielectric elastomer actuator.

### BACKGROUND ART

Various suggestions regarding dielectric elastomer actuators have been made in the past, and, for example, stack dielectric elastomer actuators, rolled dielectric elastomer actuators, and fiber dielectric elastomer actuators have been suggested. Those use the characteristics in that elastomer shrinks in a direction vertical to an electrode surface (extends in an in-plane direction).

Patent Literature 1 indicated below discloses, as an example of such dielectric elastomer actuators, an actuator that includes a dielectric elastomer and a plurality of voltage-applied members arranged through the dielectric elastomer, where the actuator operates by voltage being applied between the plurality of voltage-applied members, the voltage-applied member is formed into a fabric using stretchable thread including coiled thread made of carbon fiber, and the voltage-applied member is stretchable in response to the dielectric elastomer being deformed due to the application of the voltage (claim 1).

### CITATION LIST

### Patent Literature

Patent Literature 1: Japanese Patent Application Laid-open No. 2008-113544

### DISCLOSURE OF INVENTION

### Technical Problem

It may be desirable that dielectric elastomer actuators (hereinafter also referred to as “DEAs”) be made smaller in size so that the actuators can be used in various apparatuses.

With respect to the rolled dielectric elastomer actuators (hereinafter also referred to as “rDEAs”) from among the three types of DEAs described above, there are specific issues caused due to a structure or an operation thereof. For example, an rDEA includes a rolled body of a laminate that is formed into a sheet and obtained by stacking an electrode layer and a dielectric elastomer layer alternately. The electrode layer is connected to a circuit in order for voltage to be applied to deform the rolled body.

The prevention of a short in the circuit is one of the important issues. In particular, the possibility of causing a short circuit is increased as the rDEA is made smaller in size. Thus, it is especially important to prevent a short circuit from being caused.

Further, the prevention of an increase in connection resistance in a connection portion in which the electrode layer and the circuit are connected to each other is also one of the important issues. In particular, the area of the connection portion is made smaller as the rDEA is made smaller in size. Thus, it is also important to deal with the increase in connection resistance.

Therefore, it is an object of the present disclosure to solve at least one of these issues that may be caused due to the rDEA being made smaller in size.

### Solution to Problem

The inventors have found out that at least one of these issues can be solved using a rolled dielectric elastomer actuator that has a specific structure. In other words, the present disclosure provides a rolled dielectric elastomer actuator that includes a rolled body of a laminate including at least one pair of complimentary electrode layers and a dielectric elastomer layer, the rolled body including at least one stepped bottom surface.

The rolled body may include at least first and second steps in one stepped bottom surface from among the at least one stepped bottom surface, one of electrode layers of the at least one pair of complimentary electrode layers may be exposed from the first step, and another of the electrode layers of the at least one pair of complimentary electrode layers may be exposed from the second step.

The rolled body may include at least first and second steps in one stepped bottom surface from among the at least one stepped bottom surface, and the steps may be arranged concentrically.

The rolled body may include, in one stepped bottom surface from among the at least one stepped bottom surface, two steps that are an inner-diameter-side step and an outer-peripheral-side step, and the rolled body may have a structure in which the inner-diameter-side step is recessed or protrudes with respect to the outer-peripheral-side step.

The rolled body may include, in one stepped bottom surface from among the at least one stepped bottom surface, three steps that are an inner-diameter-side step, an outer-peripheral-side step, and a midway step situated between the two steps, and the midway step may be recessed or protrudes with respect to the inner-diameter-side step and/or the outer-peripheral-side step.

In an embodiment, no electrodes may be exposed from the outer-peripheral-side step.

In an embodiment, no electrodes may be exposed from the midway step.

Two bottom surfaces of the rolled body may be stepped bottom surfaces.

In an embodiment, at least one of electrode layers of the at least one pair of complimentary electrode layers may include at least two electrically unconnected electrodes.

The at least two electrically unconnected electrodes may be respectively exposed from different steps of one stepped bottom surface from among the at least one stepped bottom surface.

The at least two electrically unconnected electrodes may be formed in one of the electrode layers such that a specified pattern is formed.

The dielectric elastomer actuator may be configured to enable voltage to be applied to the at least two electrically unconnected electrodes in an independent manner.

The dielectric elastomer actuator may be configured to be extendable and shrinkable in a direction of an axis of the rolled body.

The dielectric elastomer actuator may be configured such that the rolled body is bendable.

The dielectric elastomer actuator may further include a cap portion that is fitted into the stepped bottom surface.

Further, the present disclosure also provides a transducer that includes a rolled body of a laminate including at least one pair of complimentary electrode layers and a dielectric elastomer layer, the rolled body including at least one stepped bottom surface.

Furthermore, the present disclosure also provides an apparatus that includes the dielectric elastomer actuator.

The apparatus may be an operation input apparatus or an endoscope apparatus.

Further, the present disclosure also provides an information processing system that includes the apparatus.

Furthermore, the present disclosure also provides a method for manufacturing a dielectric elastomer actuator, the method including a stacking step to form a laminate in which an electrode layer and an elastomer layer are stacked alternately; an external shape adjusting step to adjust an external shape of the laminate; and a rolled body forming step to form a rolled body by rolling the laminate of which the external shape has been adjusted, the external shape adjusting step being performed such that the rolled body includes at least one stepped bottom surface.

### BRIEF DESCRIPTION OF DRAWINGS

FIG. 1 is a schematic diagram used to describe a driving principle of a DEA.

FIG. 2 schematically illustrates a basic structure of a rolled DEA.

FIG. 3 illustrates an example of patterning of a complimentary electrode layer.

FIG. 4 illustrates an example of a flowchart of a method for manufacturing an rDEA.

FIG. 5 illustrates an example of a flowchart of a laminate forming step.

FIG. 6 is a schematic diagram used to describe the laminate forming step.

FIG. 7 illustrates an example of a flowchart of a rolled body forming step.

FIG. 8 is a schematic diagram used to describe a rolling step.

FIG. 9 is a schematic diagram used to describe a change step.

FIG. 10 is a schematic diagram used to describe a removal step.

FIG. 11 is a schematic diagram used to describe an adhesive layer.

FIG. 12 schematically illustrates an exposure of an electrode layer from an inner-diameter side of a rolled body.

FIG. 13 is a schematic diagram used to describe a cutting step.

FIG. 14 is a schematic diagram used to describe the cutting step.

FIG. 15 illustrates an example of a flowchart of a modularization step.

FIG. 16A is a schematic diagram used to describe an example of a configuration of an rDEA according to the present disclosure.

FIG. 16B is a schematic diagram used to describe the example of the configuration of the rDEA according to the present disclosure.

FIG. 16C is a schematic diagram used to describe the example of the configuration of the rDEA according to the present disclosure.

FIG. 16D is a schematic diagram used to describe the example of the configuration of the rDEA according to the present disclosure.

FIG. 16E is a schematic diagram used to describe the example of the configuration of the rDEA according to the present disclosure.

FIG. 16F is a schematic diagram used to describe the example of the configuration of the rDEA according to the present disclosure.

FIG. 16G is a schematic diagram used to describe an example of the configuration of the rDEA according to the present disclosure.

FIG. 17A is a schematic diagram used to describe a rolled body including a stepped bottom surface with two steps and a method for manufacturing the rolled body.

FIG. 17B is a schematic diagram used to describe the rolled body including the stepped bottom surface with the two steps and the method for manufacturing the rolled body.

FIG. 17C is a schematic diagram used to describe the rolled body including the stepped bottom surface with the two steps and the method for manufacturing the rolled body.

FIG. 17D is a schematic diagram used to describe the rolled body including the stepped bottom surface with the two steps and the method for manufacturing the rolled body.

FIG. 17E is a schematic diagram used to describe the rolled body including the stepped bottom surface with the two steps and the method for manufacturing the rolled body.

FIG. 18 is a schematic diagram used to describe a rolled body including a stepped bottom surface with two steps and the method for manufacturing the rolled body.

FIG. 19A is a schematic diagram used to describe a rolled body including a stepped bottom surface with three steps and a method for manufacturing the rolled body.

FIG. 19B is a schematic diagram used to describe the rolled body including the stepped bottom surface with the three steps and the method for manufacturing the rolled body.

FIG. 19C is a schematic diagram used to describe the rolled body including the stepped bottom surface with the three steps and the method for manufacturing the rolled body.

FIG. 19D is a schematic diagram used to describe the rolled body including the stepped bottom surface with the three steps and the method for manufacturing the rolled body.

FIG. 19E is a schematic diagram used to describe the rolled body including the stepped bottom surface with the three steps and the method for manufacturing the rolled body.

FIG. 19F is a schematic diagram used to describe the rolled body including the stepped bottom surface with the three steps and the method for manufacturing the rolled body.

FIG. 20A is a schematic diagram used to describe a rolled body including a stepped bottom surface with three steps and a method for manufacturing the rolled body.

FIG. 20B is a schematic diagram used to describe the rolled body including the stepped bottom surface with the three steps and the method for manufacturing the rolled body.

FIG. 20C is a schematic diagram used to describe the rolled body including the stepped bottom surface with the three steps and the method for manufacturing the rolled body.

FIG. 20D is a schematic diagram used to describe the rolled body including the stepped bottom surface with the three steps and the method for manufacturing the rolled body.

FIG. 20E is a schematic diagram used to describe the rolled body including the stepped bottom surface with the three steps and the method for manufacturing the rolled body.

FIG. 21A is a schematic diagram used to describe a rolled body including two stepped bottom surfaces and a method for manufacturing the rolled body.

FIG. 21B is a schematic diagram used to describe the rolled body including the two stepped bottom surfaces and the method for manufacturing the rolled body.

FIG. 21C is a schematic diagram used to describe the rolled body including the two stepped bottom surfaces and the method for manufacturing the rolled body.

FIG. 21D is a schematic diagram used to describe the rolled body including the two stepped bottom surfaces and the method for manufacturing the rolled body.

FIG. 22A is a schematic diagram used to describe a rolled body including pattern electrodes and a method for manufacturing the rolled body.

FIG. 22B is a schematic diagram used to describe the rolled body including the pattern electrodes and the method for manufacturing the rolled body.

FIG. 22C is a schematic diagram used to describe the rolled body including the pattern electrodes and the method for manufacturing the rolled body.

FIG. 22D is a schematic diagram used to describe the rolled body including the pattern electrodes and the method for manufacturing the rolled body.

FIG. 22E is a schematic diagram used to describe the rolled body including the pattern electrodes and the method for manufacturing the rolled body.

FIG. 23A schematically illustrates an example of a configuration of an operation input apparatus according to the present disclosure.

FIG. 23B schematically illustrates an example of a configuration of an operation input apparatus according to the present disclosure.

FIG. 23C schematically illustrates an example of a configuration of an operation input apparatus according to the present disclosure.

FIG. 24 schematically illustrates an example of a configuration of an operation input apparatus that includes a plurality of rDEAs.

FIG. 25 schematically illustrates an example of a configuration of an endoscope apparatus according to the present disclosure.

FIG. 26A is a block diagram illustrating an example of a configuration of an information processing system according to the present disclosure.

FIG. 26B is a block diagram illustrating the example of the configuration of the information processing system according to the present disclosure.

### MODE(S) FOR CARRYING OUT THE INVENTION

Favorable embodiments for carrying out the present disclosure will now be described below. Note that embodiments described below are representative embodiments of the present disclosure, and the scope of the present disclosure is not limited to the embodiments described below.

The present disclosure is described in the following order.
1. First Embodiment (rDEA)
1.1 Driving Principle of DEA
1.2 Overview of Present Disclosure
1.3 Method for Manufacturing rDEA
1.3.1 Laminate Forming Step
1.3.2 Rolled Body Forming Step
1.3.3 Modularization Step
1.4 rDEA According to Present Disclosure
1.4.1 First Example (Rolled Body Including Stepped Bottom Surface with Two Steps and Method for Manufacturing Rolled Body)
1.4.2 Second Example (Rolled Body Including Stepped Bottom Surface with Two Steps and Method for Manufacturing Rolled Body)
1.4.3 Third Example (Rolled Body Including Stepped Bottom Surface with Three Steps and Method for Manufacturing Rolled Body)
1.4.4 Fourth Example (Rolled Body Including Stepped Bottom Surface with Three Steps and Method for Manufacturing Rolled Body)
1.4.5 Fifth Example (Rolled Body Including Two Stepped Bottom Surfaces and Method for Manufacturing Rolled Body)
1.4.6 Sixth Example (Rolled Body Including Pattern Electrodes and Method for Manufacturing Rolled Body)
1.5 Method for Manufacturing rDEA According to Present Disclosure
2. Second Embodiment (Transducer)
3. Third Embodiment (Apparatus or System)
3.1 Example of Configuration of Apparatus (Button)
3.2 Example of Configuration of Apparatus (Plurality of rDEAs)
3.3 Example of Configuration of Apparatus (Endoscope Apparatus)
3.4 Example of Configuration of Information Processing System

### 1. First Embodiment (rDEA)

### 1.1 Driving Principle of DEA

A DEA includes a dielectric elastomer and a pair of electrodes used to apply voltage to the dielectric elastomer. Electrodes of the pair of electrodes are pulled together by voltage being applied to the dielectric elastomer using the pair of electrodes. This results in deformation of the dielectric elastomer.

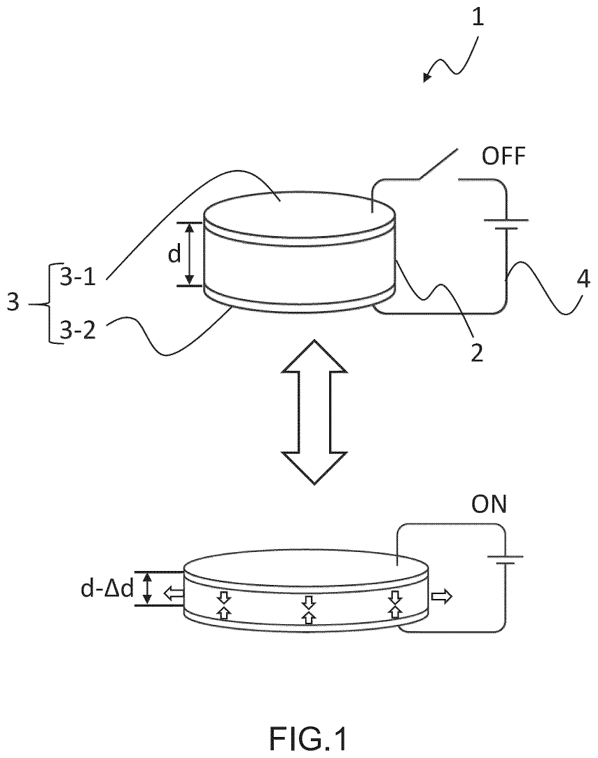

A principle of the deformation is described with reference to FIG. 1. The figure schematically illustrates a DEA. A DEA 1 includes a dielectric elastomer 2 and a pair of electrodes 3. The pair of electrodes 3 is arranged such that the dielectric elastomer 2 is situated between electrodes of the pair of electrodes 3, that is, an electrode 3-1 that is one of the pair of electrodes 3, the dielectric elastomer 2, and an electrode 3-2 that is another of the pair of electrodes 3 are stacked in this order. The pair of electrodes 3 is a portion of a circuit 4.

When voltage in the circuit 4 is off, the dielectric elastomer 2 has a thickness d in a direction that extends vertically to surfaces of the two electrodes, as illustrated in an upper portion of the figure.

When the voltage in the circuit 4 is turned on, voltage is applied between the two electrodes, as illustrated in a low portion of the figure. This results in the two electrodes being pulled together. As a result, the dielectric elastomer 2 shrinks in the direction extending vertically to the electrode surfaces, and extends in an in-plane direction. Accordingly, the thickness of the dielectric elastomer 2 in the direction extending vertically to the surfaces of the two electrodes is changed to d-Ad.

The DEA 1 can be used as a movable member due to the deformation described above.

Here, with respect to the shrinkage of the dielectric elastomer 2, a generated force and distortion in the shrinkage direction can be represented using respective formulas indicated below, where an applied voltage is V, a dielectric constant of the dielectric elastomer is ε, and a Young's modulus of the dielectric elastomer is Y.

$$Generated force P ∝ {ε ( \frac{V}{d} )}^{2} \qquad [ Math . 1 ]$$

$$Distortion s ∝ \frac{ε}{Y} {( \frac{V}{d} )}^{2}$$

As can be seen from these formulas, the adjustment of voltage applied to the DEA makes it possible to adjust an amount of deformation of and a generated force of the DEA.

A rolled DEA (rDEA) is an example of the DEA. The rDEA has, for example, a basic structure schematically illustrated in FIG. 2. An rDEA 5 illustrated in the figure includes a rolled body 6 of a laminate including at least one pair of complimentary electrode layers and a dielectric elastomer layer. The laminate may include a plurality of dielectric elastomer layers. Further, each of the plurality of dielectric elastomer layers may be situated between two electrode layers. The at least one pair of complimentary electrode layers may be electrically connected to a circuit 7. For example, the complimentary electrode layers (or electrodes electrically connected to the complimentary electrode layers) may be exposed from one of two bottom surface portions (bottom surface portions of a cylindrical form) of the rolled body or from the two bottom surface portions, and the exposed complimentary electrode layers may be connected to the circuit 7. Further, when voltage in the circuit 7 is turned on or off, the rolled body 6 extends or shrinks in a direction of a height of the cylindrical form, as illustrated in the figure. The extension or the shrinkage may be used as movability of the rDEA.

### 1.2 Overview of Present Disclosure

Issues of the present disclosure are described below in more detail.

In order to connect a complimentary electrode of an rDEA to a circuit, electrode layers may be offset from each other to create a laminate, and the circuit may be connected to respective complimentary electrode layers of the pair of complimentary electrode layers through two bottom surfaces of a cylindrical form of a rolled body (an upper surface and a lower surface in a long-axis direction). In this case, the circuit is connected to the two bottom surfaces of the rolled body 6, as illustrated in, for example, FIG. 2 described above.

However, when a circuit is connected to two bottom surfaces of a rolled body, a relative positional relationship between the two bottom surfaces is changed according to deformation of the rolled body. For example, a position of one of two portions at which the rolled body and the circuit are connected is fixed, and another of the two portions is moved. It is not desirable that wiring be provided to such a moving portion from the perspective of, for example, the stability of a circuit or the robustness of an apparatus.

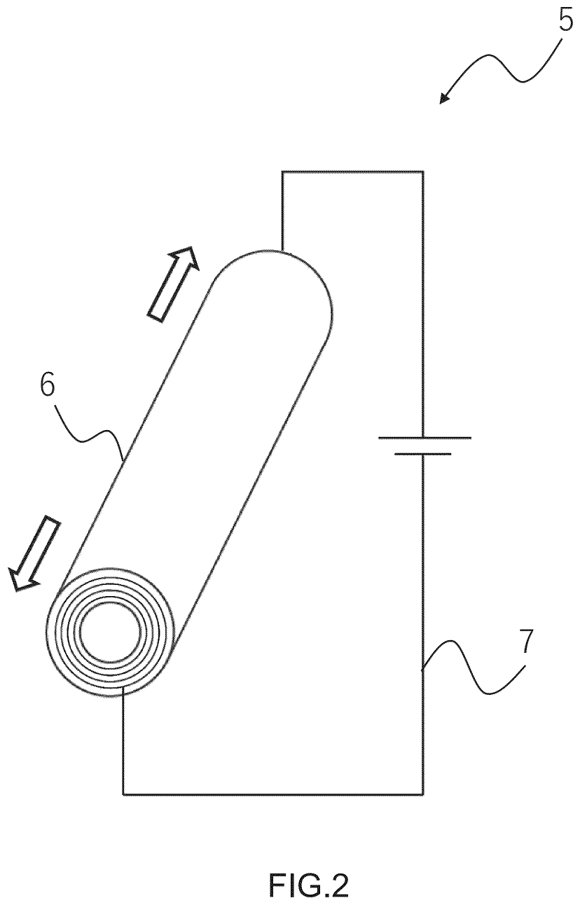

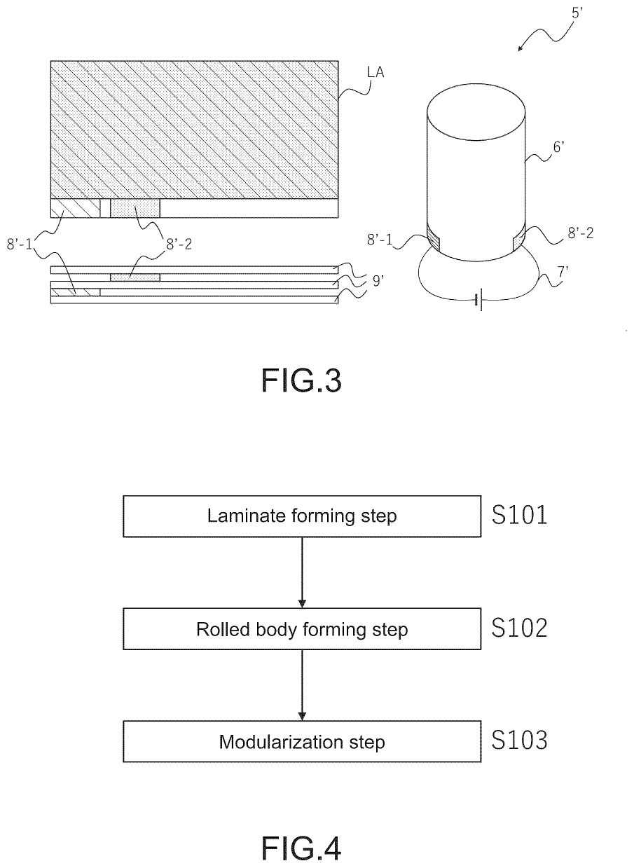

Thus, a configuration in which a connection portion at which a complimentary electrode layer and a circuit are connected to each other is only provided to one of bottom surfaces, may be adopted. In order for an rDEA to have such a configuration, for example, an electrode layer may be patterned, and the complimentary electrode layer may be connected to a circuit through one of bottom surfaces. An example of such patterning is described with reference to FIG. 3. An rDEA 5′ illustrated on the right in the figure has a configuration in which a rolled body 6′ is connected to a circuit 7′. In order to connect the rolled body 6′ and the circuit 7′, the rolled body 6′ includes taken-electrode portions 8′-1 and 8′-2 used to connect a complimentary electrode layer included in the rolled body 6′ and the circuit. For example, such a taken-electrode portion 8′-1 may be formed by patterning, as illustrated on the left in the figure, an electrode layer in a laminate LA used to form the rolled body.

Note that, in a top view on the upper left in the figure, complimentary electrode layers (respectively indicated by dots and hatching) that are not seen normally due to presence of a dielectric elastomer layer 9′ is illustrated, in order to achieve a better understanding of a positional relationship between a taken-electrode portion and an electrode layer. In a cross-sectional view of a laminate on the lower left in the figure, the entirety of the complimentary electrode layer is not illustrated, but only the taken-electrode portion is illustrated, in order to achieve a better understanding of a position of the taken-electrode portion.

However, two electrodes are situated in one of bottom surfaces. Thus, there is a need to prevent a short circuit caused between these electrodes. Further, there is a need to make the area of each electrode in order for the two electrodes in one of the bottom surfaces. This may result in an increase in connection resistance. These issues particularly become large issues when an rDEA is made smaller in size or when each layer included in a rolled body is made thinner.

The inventors have found out that at least one of these issues can be solved using an rDEA that has a specific structure (especially a rolled body included in the rDEA). In other words, the present disclosure provides a rolled dielectric elastomer actuator that includes a rolled body of a laminate including at least one pair of complimentary electrode layers and a dielectric elastomer layer, the rolled body including at least one stepped bottom surface. For example, when there is the at least one stepped bottom surface, electrodes of a plurality of electrodes used to connect an electrode layer and a circuit are respectively provided to different steps of one stepped bottom surface. This makes it possible to prevent a short circuit from being caused. Further, an electrode can be made larger in size. This makes it possible to prevent an increase in connection resistance.

As described above, the rolled body including a stepped bottom surface is useful for an rDEA, but the rolled body may be incorporated into another apparatus. The rolled body may be incorporated into, for example, a transducer. In other words, the present disclosure also provides the rolled body. Further, the present disclosure also provides a transducer including the rolled body.

The stepped bottom surface is also useful from perspectives other than the perspective of solving electrode-related issues. For example, the stepped bottom surface may be used to, for example, couple another component to the rolled body. The stepped bottom surface enables the other component to be fitted into the rolled body. Accordingly, the rolled body is coupled to the other component more strongly.

Further, the stepped bottom surface can be formed by adjusting a form of a laminate rolled in order to manufacture a rolled body. In other words, the stepped bottom surface can be formed easily upon manufacturing a rolled body.

In the present disclosure, one of bottom surfaces of a rolled body may be a stepped bottom surface, or both of the bottom surfaces may be stepped bottom surfaces. When both of the bottom surfaces are stepped bottom surfaces, the plurality of electrodes may be provided to one of the stepped bottom surfaces, and another of the stepped bottom surfaces may be used to fit another component (such as a cap or a housing) into the rolled body.

In an embodiment, the rolled body may include at least first and second steps in one stepped bottom surface, where one of the at least one pair of complimentary electrode layers may be exposed from the first step and another of the at least one pair of complimentary electrode layers may be exposed from the second step. When respective electrode layers are provided to different steps, as described above, this results in preventing a short circuit from being caused. More specific examples of such an embodiment are described in 1.4 indicated below.

The rolled body may include at least first and second steps in one stepped bottom surface, and these steps may be arranged concentrically. In other words, each stepped bottom surface may be a bottom surface that includes at least two steps concentrically arranged generally about an axis of the rolled body. Such a stepped bottom surface can be formed by adjusting a structure of a laminate sheet that is rolled in order to form a rolled body. This makes it possible to perform manufacturing efficiently. For example, there is no need to change, after rolling, a form of a bottom surface of a rolled body to a stepped bottom surface.

It is sufficient if the stepped bottom surface includes at least two steps. The number of steps included in the stepped bottom surface may be adjusted as appropriate according to a desired structure of an rDEA. The number of steps may be, for example, two, three, four, or five, but may be more than five. From the perspective of ease of manufacturing, the number of steps included in the stepped bottom surface is favorably two, three, or four, and more favorably two or three.

The dielectric elastomer actuator according to the present disclosure may be configured to be extendable and shrinkable in a direction of an axis of the rolled body, or may be configured such that the rolled body can be bent. For example, configurations in first to sixth examples in 1.4 indicated below may be adopted in order to enable the extension and shrinkage. Further, the configuration in the sixth example in 1.4 indicated below may be adopted in order for the rolled body to be bent.

In the following description, in order to achieve a better understanding of the present disclosure, a method for manufacturing an rDEA that can be applied to both an rDEA that does not include a stepped bottom surface and an rDEA that includes a stepped bottom surface, is described, and subsequently, a structure of the rDEA including a stepped bottom surface and a method for manufacturing the rDEA including a stepped bottom surface are described.

1.3 Method for Manufacturing rDEA

The method for manufacturing an rDEA is described with reference to FIG. 4. As indicated by the flowchart in the figure, the method for manufacturing an rDEA may include a laminate forming step S101 to obtain a laminate including an electrode layer and a dielectric elastomer layer, a rolled body forming step S102 to obtain a rolled body by rolling the laminate, and a modularization step S103 to form an rDEA by modularizing the rolled body. These manufacturing steps are described below.

### 1.3.1 Laminate Forming Step

A laminate including at least one pair of complimentary electrode layers and a dielectric elastomer layer is formed in order to manufacture an rDEA.

The number of pairs of the complimentary electrode layers included in the laminate may be one, or at least two (such as two pairs, three pairs, or four pairs).

The number of the dielectric elastomer layers included in the laminate may be at least one, and favorably at least two. For example, the number may be two, three, or four. Each dielectric elastomer layer may be situated between complimentary electrode layers of a pair of complimentary electrode layers or between complimentary electrode layers of at least two pairs of complimentary electrode layers. In the latter case, at least two electrode layers may be patterned in one of surfaces of one dielectric elastomer layer such that the at least two electrode layers are not electrically connected to each other. The patterning enables an rDEA to not only extend and shrink in a single-axis direction but also to be bent in any direction.

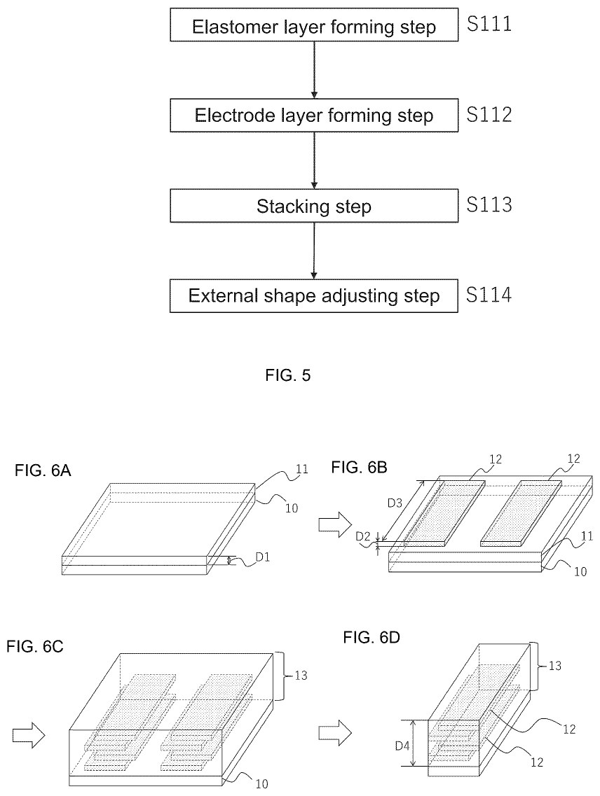

A method for manufacturing the laminate may include, for example, an elastomer layer forming step S111, an electrode layer forming step S112, a stacking step S113, and a cut-out step S114, as indicated by, for example, a flowchart in FIG. 5. For example, these steps may be performed, as described below.

### (Elastomer Layer Forming Step S111)

In the elastomer layer forming step S111, a dielectric elastomer layer 11 is formed on a base member layer 10, as illustrated in (a) of FIG. 6. The dielectric elastomer layer may be formed by coating the base member layer with an elastomer material and by curing the elastomer material, or may be formed by laminating, over the base member layer, a dielectric elastomer layer cured in advance.

For example, a thickness D1 of the dielectric elastomer layer 11 may be 100 μm or less, favorably 90 μm, 80 μm or less, 70 μm or less, or 60 μm or less, and more favorably 50 μm or less.

For example, the thickness D1 of the dielectric elastomer layer 11 may be 0.1 μm or greater, favorably 0.3 μm or greater, 0.5 μm or greater, or 0.7 μm or greater, and more favorably 1 μm or greater.

Each of an upper limit and a lower limit of a numerical-value range for the thickness D1 of the dielectric elastomer layer 11 may be selected from the numerical values listed above. For example, the thickness D1 may be 0.1 μm-100 μm, and favorably 1 μm-50 μm.

Voltage necessary for driving can be reduced by making a dielectric elastomer layer thinner. Further, a high insulting performance can be expected to be achieved by making a dielectric elastomer layer thicker. The numerical-value range having the upper and lower limits described above are suitable for reducing voltage necessary for driving and for preventing dielectric breakdown.

The dielectric elastomer layer 11 may be, for example, an insulating and elastic layer, and in particular, the dielectric elastomer layer 11 may be formed using an insulating elastomer. For example, the insulating elastomer may be a material obtained by curing an elastomer material that includes at least one of silicone resin, acrylic resin, or urethane resin as a principal component. In other words, the elastomer layer may be a silicone-based elastomer, an acrylic-based elastomer, or a urethane-based elastomer.

The elastomer material may include any additive. For example, the additive may include at least one of a crosslinker, a plasticizer, an antioxidant, a surfactant, a viscosity modifier, a reinforcement, or a colorant. A composition of the elastomer material may be selected as appropriate by those skilled in the art in this technical field. In other words, the dielectric elastomer layer may include at least one of these additives.

The base member layer 10 may be a base material that is formed using, for example, polyester-based resin, especially PET resin, or may be a base member that is formed using another material (such as polyolefin-based resin or polycarbonate-based resin). A material of the base member layer may also be selected as appropriate by those skilled in the art in this technical field.

Surface activation processing may be performed on the dielectric elastomer layer. For example, the surface activation processing is performed on a surface that is from between two surfaces of the elastomer layer and on which an electrode layer is stacked. For example, the surface activation processing may be plasma processing, corona discharge processing, or both of them. The surface activation processing results in improving interlayer adhesion, and thus in preventing unsticking of layers.

Further, the surface activation processing may be performed on another surface for which interlayer adhesion is desired to be improved.

For example, hydroxyl groups are given to a surface of a silicone-based elastomer by plasma processing being performed. This results in improving interlayer adhesion. For example, the surface activation processing may be performed before an electrode layer forming step S112. As a result, hydroxyl groups are given to a surface of a dielectric elastomer layer by the processing being performed. This leads to better wetting of an electrode layer forming material (such as an electrode paste), and then the improvement of printability can be expected. Further, the surface activation effect also contributes toward improving properties of adhesion of dielectric elastomer layers.

### (Electrode Layer Forming Step S112)

In the electrode layer forming step S112, the elastomer layer 11 is coated with an electrode layer 12, or the electrode layer 12 is printed onto the elastomer layer 11, as illustrated in (b) of FIG. 6. Favorably, the electrode layer 12 may be formed by screen printing. A conductive substance included in the electrode layer 12 may be, for example, carbon black, carbon nanotube (CNT), metallic filler, or a combination of at least two of them. For example, the electrode layer may be a layer formed by printing of a conductive ink including a conductive substance, and more specifically, the electrode layer may be a layer formed by screen printing of the conductive ink.

When an rDEA according to the present disclosure is manufactured, the electrode layer 12 is formed such that a specified pattern is formed. The specified pattern has a shape in which each electrode layer is exposed from a cross section of a corresponding one of at least two side portions formed by cutting a portion out of a laminate to form the laminate into a specified shape, as described later. A more specific example of the pattern will be described later.

For example, a thickness D2 of the electrode layer 12 is 10 μm or less, and favorably 7 μm or less, 5 μm or less, or 3 μm or less. More favorably, the thickness D2 is 1 μm or less. In some embodiments, the thickness D2 of the electrode layer 12 may be, for example, 500 nm or less, 400 nm or less, 300 nm or greater, or 200 μm or less.

For example, the thickness D2 of the electrode layer 12 may be 10 nm or greater, and more favorably 20 nm or greater.

Each of an upper limit and a lower limit of a numerical-value range for the thickness D2 of the electrode layer 12 may be selected from the numerical values listed above. For example, the thickness D2 may be 10 nm-10 μm, and favorably 20 nm-1 μm.

When an electrode layer is thin, this contributes towards making a device lighter in weight and less rigid. On the other hand, when an electrode layer is too thin, this may result in a reduction in electrode coverage or an increase in an electric resistance of the electrode layer. A thickness of an electrode layer may be designed as appropriate by those skilled in the art according to, for example, the type of filler (having influence on electric resistance). For example, in the case of a CNT electrode, an electrode layer may have a thickness of about tens of nanometers, and an electrode layer including carbon-black-based filler may have a thickness of, for example, about tens of micrometers.

A length D3 in a rolling direction of the electrode layer 12 may be selected as appropriate by those skilled in the art according to a size of an rDEA to be manufactured, and does not necessarily have to be particularly limited. The length D3 may be, for example, 10 mm or greater, 20 mm or greater, 30 mm or greater, 40 mm or greater, or 50 mm or greater.

Further, an upper limit of the length D3 in the rolling direction of the electrode layer 12 also does not necessarily have to be particularly limited. The upper limit of the length D3 may be, for example, 500 mm or less, 400 mm or less, 300 mm or less, or 200 mm or less.

Each of an upper limit and a lower limit of a numerical-value range for the length D3 in the rolling direction of the electrode layer 12 may be selected from the numerical values listed above. For example, the length D3 may be 10 mm-500 mm, and favorably 20 mm-400 mm.

In an embodiment, the conductive ink may be conductive paste that includes carbon black and a binder component. In another embodiment, the conductive ink may be a conductive coating material that includes CNT. Such conductive ink is applied to the elastomer layer to form an electrode layer. In order to form the electrode layer, a curing step or a drying step may be performed as necessary after the application of the conductive ink.

### (Stacking Step S113)

In the stacking step S113, a second laminate obtained by stacking an electrode layer on a dielectric elastomer layer may be stacked on a first laminate obtained by stacking an electrode layer on a dielectric elastomer layer. In the stacking step S13, two laminates may be stacked on top of each other, and at least one different laminate obtained by stacking an electrode layer on a dielectric elastomer layer may be further stacked on the two laminates. In the stacking step S13, laminates each including an electrode layer and a dielectric elastomer layer may be stacked on top of each other, as described above. Accordingly, a laminate in which an electrode layer and a dielectric elastomer layer are stacked alternately, is formed.

Alternatively, an electrode layer may be formed on a dielectric elastomer layer, then an additional elastomer layer may be further stacked on the electrode layer, and then an additional electrode later may be further formed on the additional elastomer layer. Thereafter, an additional elastomer layer and an additional electrode layer may be further stacked thereon sequentially. In the stacking step S13, an electrode layer and an elastomer layer may be formed alternately, as described above.

As described above, in the stacking step S13, an electrode layer and an elastomer layer are stacked alternately, and a laminate 13 including at least one pair of complimentary electrode layers is obtained, as illustrated in (c) of FIG. 6.

For example, a thickness D4 of the laminate 13 (that is, a thickness of a laminate sheet to be rolled) may be 500 μm or less, 400 μm or less, or 300 μm or less, and favorably 200 μm or less. The thickness D4 may be more favorably 180 μm or less, and much more favorably 160 μm or less, 140 μm or less, 120 μm or less, or 100 μm or less.

It is desirable that the thickness D4 of the laminate 13 be thinner, and a lower limit of the thickness D4 does not necessarily have to be particularly set. For example, the thickness D4 may be 1 μm or greater, 5 μm or greater, 10 μm or greater, 15 μm or greater, 20 μm or greater, 25 μm or greater, or 30 μm or greater.

Each of an upper limit and a lower limit of a numerical-value range for the thickness D4 of the laminate 13 may be selected from the numerical values listed above. The thickness D4 may be, for example, 1 μm-500 μm, favorably, for example, 5 μm-200 μm, and more favorably 10 μm-180 μm.

### (External Shape Adjusting Step S114)

In an external shape adjusting step S114, an external shape of the laminate obtained in the stacking step S13 is adjusted. The adjustment of an external shape may be performed by cut-out being performed on the laminate. The cut-out may be performed using, for example, an ultrasonic waves cutter or a laser cutter. The cut-out is performed such that an electrode layer is exposed from a surface formed by cut-out being performed. The electrode layer 12 is exposed from a surface created by the cut-out, as illustrated in (d) of FIG. 6. The electrode layer exposed as described above is electrically connected to a circuit upon modularization described later. Accordingly, functions of an rDEA are exerted.

When an rDEA according to the present disclosure is manufactured, a position that is situated on a laminate surface and at which the cut-out is performed may be set as appropriate according to a pattern of the electrode layer described above. More specifically, the cut-out is performed such that an electrode layer is exposed from a cross-sectional surface including a side portion formed by the cut-out. In particular, the cut-out is performed such that one electrode layer is exposed from one cross-sectional surface. Examples of the cut-out are described in 1.4 indicated below.

### 1.3.2 Rolled Body Forming Step

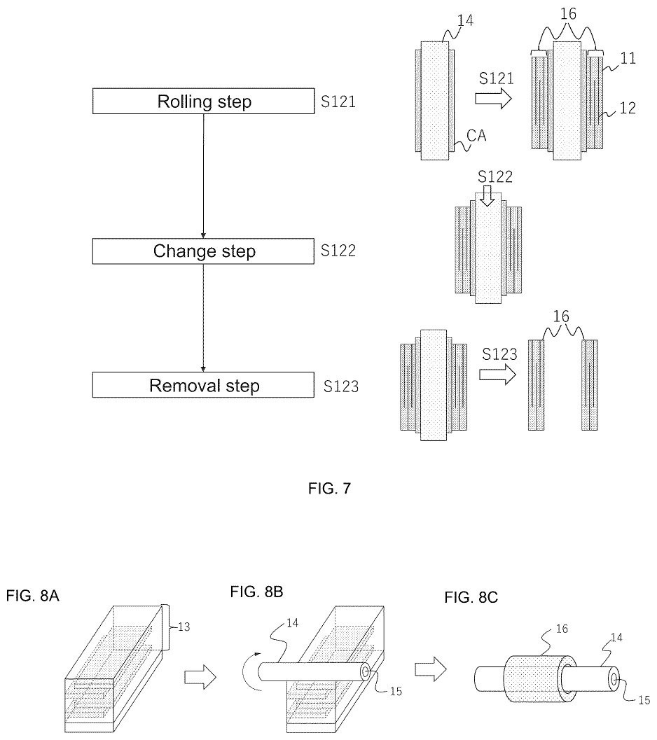

In the rolled body forming step, a rolled body is formed using the laminate formed in the laminate forming step. The rolled body forming step includes a rolling step S121 to roll the laminate around a core to obtain a rolled body, a change step S122 to change a state of the core after the rolling step, and a removal step S123 to remove the core from the rolled body after the change step, as indicated by, for example, a flowchart in FIG. 7.

In the rolling step S121, the laminate is rolled around the core 14 to form a rolled body 16, as illustrated in the figure. An adhesive layer CA may be provided to an outer periphery of the core 14, as described later, and the core 14 and the rolled body 16 may be bonded to each other through the adhesive layer CA, as illustrated in the figure. In the change step S122, there is a change in a state of the core 14. In the change step, there may also be a change in a state of the adhesive layer CA. Then, in the removal step S123, the core 14 is removed from the rolled body 16. In the removal step, the adhesive layer CA may also be removed. When a rolled body is manufactured as described above, a size of an rDEA (a rolled body in particular) can be controlled by an outer diameter of a core, as well as a thickness and a length of the laminate.

Further, the adhesive layer makes it possible to improve tack of a laminate and a core in the rolling step S121. Further, the core is easily removed by a state of the adhesive layer being changed (such as melting) in the change step S122.

Further, the rolled body forming step may include a cutting step described later. The cutting step may be performed at any stage after the rolling step. Favorably, the cutting step may be performed before, in the middle of, or after the change step.

As described above, the manufacturing method using a core makes it possible to efficiently manufacture a small rDEA, and further makes it possible to prevent a defect such as wrinkles on the manufactured rDEA from being caused. The above-described use of a core is particularly useful for mass production.

When an rDEA according to the present disclosure is manufactured, a stepped bottom surface may be formed by performing the rolled body forming step. This makes it possible to form a stepped bottom surface efficiently.

Steps that may be included in the rolled body forming step are respectively described in detail below.

### (Rolling Step S121)

In the rolling step S121, the laminate 13 is rolled around the core 14 to form the rolled body 16, as illustrated in (1) to (3) of FIG. 8. In other words, at least one pair of complimentary electrode layers and a dielectric elastomer layer are rolled around the core 14 in this step. Note that the figure illustrates the laminate 13 such that a thickness of the laminate 13 is emphasized, that is, the figure illustrates the laminate 13 larger than the core 14, in order to achieve a better understanding (in particular, in order to better understand that it is a laminate including an elastomer layer and an electrode layer. It goes without saying that the figure does not indicate an actual dimensional relationship between the laminate and the core. Further, the laminate 13 illustrated in each of (1) and (2) and the laminate 13 illustrated in (3) in the figure have completely different thicknesses. This is also in order to achieve a better understanding. It also goes without saying that such a change in thickness is actually not caused.

In the actual manufacturing method, the thickness of the laminate 13 has the dimension as described above, and is smaller than a diameter of the core 14. Further, there is not a great change in the thickness of the laminate 13 between before and after being rolled, although there is a slight change.

The core 14 may be a core in a substantially columnar form, as illustrated in (2) of FIG. 8.

The core in a substantially columnar form may have a space 15 in a portion corresponding to a central axis of the column. The core may be a hollow core in a substantially columnar form, that is, the core may be in a substantially cylindrical form. As a result, the core is easily affected by liquid or heat, and a change is caused more efficiently in the change step described later.

In the core in a substantially columnar form, the space 15 in a portion corresponding to the central axis of the column may be occupied by a shaft made of a rigid material. The rigid material may be a material, such as metal, resin, or ceramics, that has physical properties of preventing the core from being deformed in the rolling step. This makes it possible to perform the rolling step more stably. The shaft may be pulled out of the core before the change step described later. This results in creating the space 15, and in the liquid easily penetrating the core.

For example, the core 14 may be a fiber material or a porous material. Further, the core 14 may be a metallic material or a plastic material.

Favorably, the core 14 may be a core formed using a material that liquid can penetrate. A fiber material and a porous material are examples of such a material.

The core formed using a fiber material may be a core formed using organic fiber such as pulp, cotton, or plastic fiber (including acrylic fiber, polyester-based fiber, and polyolefin-based fiber), and may be a core formed using paper in particular.

In a favorable embodiment, the material may include a cellulose component, and, for example, the material may be paper. Such a material is favorably used in particular since a core is easily changed when liquid is used to change the core in the change step described later. Further, the use of the material such as paper enables the core to be formed to have a desired degree of rigidity. For example, this makes it easier to perform cutting in the cutting step described later.

In another favorable embodiment, the material may be a resin material. The use of the resin material also enables the core to be formed to have a desired degree of rigidity. For example, this makes it easier to perform cutting in the cutting step described later.

Favorably, an adhesive material may be situated on the outer periphery of the core 14. The adhesive material contributes toward preventing a positional relationship between the core 14 and the laminate 13 from being changed in the rolling step. In other words, the core 14 may include a layer of the adhesive material (hereinafter also referred to as an adhesive layer or a bonding layer) on the outer periphery of the core 14. As a result, a rolled body obtained by the rolling step includes an adhesive layer between the core and the rolled body.

Favorably, the adhesive material is a soluble adhesive material. Particularly favorably, the adhesive material is a soluble adhesive material, and more specifically, the adhesive material may be a soluble adhesive material that is dissolved by being brought into contact with liquid used in the change step described late, or may be a soluble adhesive material that is dissolved by being brought into contact with heat (application of heat) used in the change step described later.

The adhesive material may be provided in advance to the outer periphery of the core 14 before the rolling step is performed, or may be provided to a portion of the surface of the laminate 13 that is brought into contact with the outer periphery of the core 14.

In an embodiment, the adhesive material is favorably a water-soluble adhesive since inexpensive and environment-friendly water can be selected as liquid or solvent that is used in the change step. However, the adhesive material is not limited thereto. The water-soluble adhesive may be an adhesive containing water-soluble polymers. The water-soluble polymer may be a polymer having a hydrophilic group (for example, at least one of a carboxyl group, a sulfonic acid group, an amine group, a hydroxy group, or an amide group) on at least one of a principal chain or a side chain of the polymer. In a favorable embodiment, the water-soluble polymer may polyvinyl alcohol (PVA). The polyvinyl alcohol contributes toward reducing manufacturing costs since the polyvinyl alcohol is inexpensive. As described above, the adhesive layer may contain a water-soluble polymer.

Further, the adhesive may be an acrylic-based adhesive, a silicone-based adhesive, a urethane-based adhesive, or a rubber-based adhesive, but is not limited thereto.

Furthermore, the number of layers of the adhesive is not limited to one, and may be two or more, as described later.

### (Change Step S122)

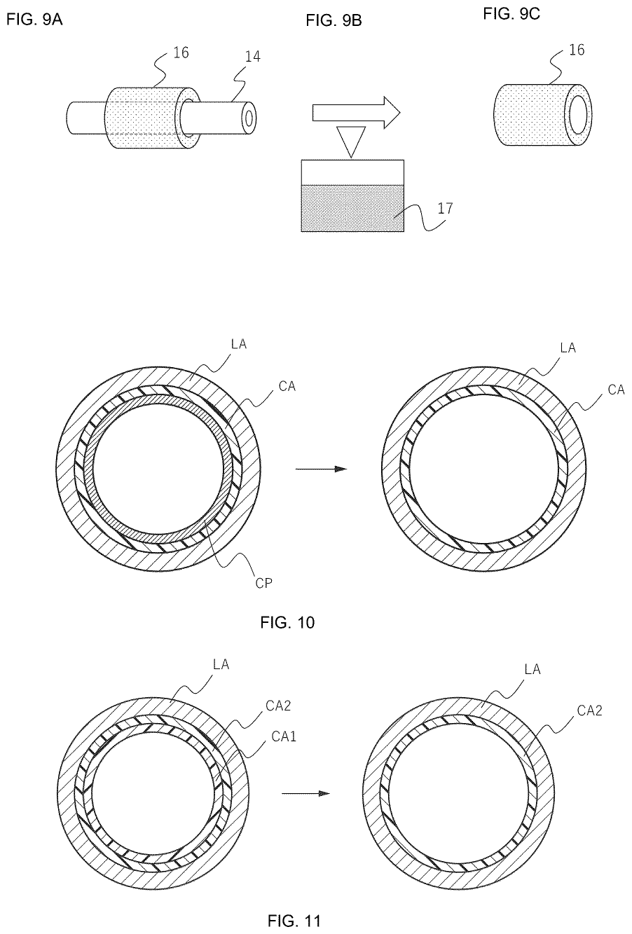

In the change step S122, a state of the core 14 is changed, as illustrated in (1) and (2) of FIG. 9. The state change may be a change that makes it easy to remove the core 14 from the rolled body 16, and in particular, a change that makes it easy to pull the core 14 out of the rolled body 16. The change may be, for example, a change that makes the core 14 softer, a change that causes the core 14 to be molten, a change that causes the core 14 to be decomposed, a change that makes the core 14 smaller in size, a change that causes the core 14 to shrink, or a change that makes the core 14 thinner. Such a change makes it possible to easily perform the removal step S123 described later.

In an embodiment, the state change may be a state change caused by the core 14 being brought into contact with liquid 17, as illustrated in (2) of FIG. 9. The contact with liquid may be made by the core 14 and rolled body 16 being immersed together in the liquid 17, or by only the core 14 being immersed in the liquid 17. Alternatively, the contact may be made by liquid penetrating the above-described hollow portion (the space 15) of the core 14.

The liquid may penetrate the core 14. More specifically, the liquid is liquid that brings about the change in the core 14. The liquid may be water or aqueous solution, or may be an organic solvent.

When, for example, the liquid is water or aqueous solution, the liquid may have a temperature of 10 °C or more, 20 °C or more, 30 °C or more, 40 °C or more, 50 °C or more, 60 °C or more, 70 °C or more, or 80 °C or more, in order to change the state more quickly. An upper limit of the temperature of the liquid does not necessarily have to be particularly set, and it is sufficient if the temperature is a temperature at which used liquid remains in a liquid state. Further, the temperature of the liquid may be adjusted as appropriate according to, for example, a heat-resistance temperature of a material of the rolled body. For example, silicone-based elastomer has a heat-resistance temperature of from 200 °C to 300 °C. The liquid may have a temperature lower than or equal to the heat-resistance temperature of the material of the rolled body.

Alternatively, the state change may be caused by the core 14 being brought into contact with gas (in particular, high-temperature gas). The gas may be, for example, water vapor. The gas may have a temperature of, for example, 100 °C or more, or 110 °C or more. An upper limit of the temperature of the gas does not necessarily have to be particularly set, and the temperature of the gas may also be adjusted as appropriate according to, for example, a heat-resistance temperature of a material of the rolled body. For example, the gas may have a temperature lower than or equal to the heat-resistance temperature of the material of the rolled body.

When, for example, the adhesive layer described above is situated around the core 14, the adhesive layer may be brought into contact with the liquid 17 in the state change. For example, the liquid having penetrated the entirety of the core 14 may be brought into contact with the adhesive layer. The adhesive layer can be dissolved or decomposed by being brought into contact with the liquid. This results in the core 14 being easily removed from the rolled body 16.

In another embodiment, the state change may be a state change caused by the core 14 being heated. In the heating, the core 14 and the rolled body 16 may be heated together, or only the core 14 may be heated (for example, by being brought into contact with a heating medium or by heating a portion of the core that corresponds to an axis of the core).

When, for example, the adhesive layer described above is situated around the core 14, the adhesive layer may be heated in the state change. The adhesive layer is heated to be dissolved, softened, or volatilized. This results in the core 14 being easily removed from the rolled body 16.

### (Removal Step S123)

In the removal step S123, the core 14 is removed from the rolled body 16. As a result, the rolled body 16 without the core 14 is obtained, as illustrated in (3) of FIG. 9. In the change step S122, the state of the core 14 is changed, as described above. Thus, the core 14 is easily removed, and, for example, the core 14 can be pulled out easily.

In the removal step S123, as a result of removing the core 14, the adhesive layer may also be removed or at least a portion of the adhesive layer may remain on an inner-diameter side of the rolled body.

Before the removal step, a rolled body with a core may have a structure including a core CP, an adhesive layer CA that covers an outer periphery of the core CP, and a rolled body LA that covers an outer periphery of the adhesive layer CA, as illustrated, for example, on the left in FIG. 10. Then, the core CP may be removed by the removal step being performed, and all of or a portion of the adhesive layer CA may remain on a surface on an inner-diameter side of the rolled body LA, as illustrated on the right in the figure. It is desirable that, when the adhesive layer CA remains in the rolled body, the adhesive layer be as flexible as the rolled body or be more flexible than the rolled body.

Alternatively, all of the adhesive layer CA may be removed due to the removal step being performed.

Further, the number of the adhesive layers may be one, or may be two or more. In other words, the adhesive layer may include at least two different types of adhesive material layers. For example, a first layer CA1 on the side of a core may be a water-soluble adhesive, and a second layer CA2 on the side of a rolled body may be a silicone-based adhesive, as illustrated on the left in FIG. 11. Note that an illustration of the core is omitted in the figure.

Then, the first layer CA1 is removed together with the core by the removal step being performed. Then, after the removal step, the second layer CA2 may remain on an inner-diameter side of a rolled body LA, as illustrated on the right in the figure.

In this case, liquid used in the change step may be liquid that easily penetrates a material of the first layer or in which the material of the first layer is easily dissolved, and that does not easily penetrate a material of the second layer or in which the material of the second layer is not easily dissolved. For example, an adhesive material of the first layer may be a water-soluble polymer (such as PVA), and an adhesive material of the second layer may be a silicone-based adhesive. In this case, liquid used in the change step may be water or aqueous solution.

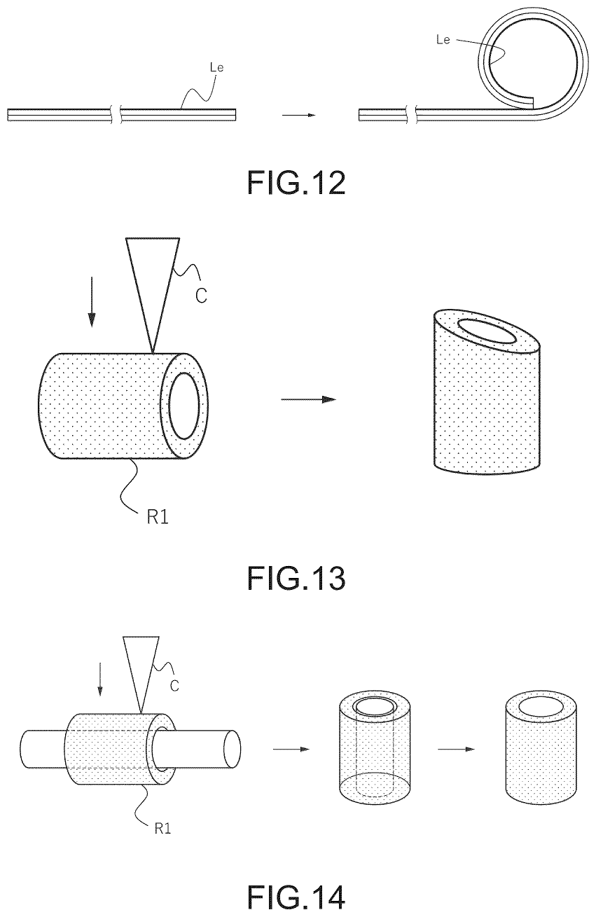

When the removal step S123 is performed, an electrode layer may be exposed from the inner-diameter side of the rolled body depending on a configuration of a laminate original sheet. As an example of the laminate original sheet having a minimum configuration, there is a laminate original sheet that includes two dielectric elastomer layers and a pair of electrode layers (that is, two electrode layers), as illustrated in, for example, FIG. 12. When the laminate original sheet having the minimum configuration is rolled up, an electrode layer Le is exposed from an inner-diameter side. Thus, an additional dielectric elastomer layer may be stacked on the exposed electrode layer, in order to avoid the exposure. Alternatively, an electrode layer may be patterned to have a specified shape, in order to avoid such exposure. The avoidance of exposure contributes toward improving the performance of an rDEA.

### (Cutting Step)

The rolled body forming step may further include the cutting step to cut the rolled body 16.

For example, the cutting step may be performed after the rolling step S121 and before the change step S122, or may be performed during the change step S122, or may be performed after the change step S122 and before the removal step S123, or may be performed after the removal step S123.

In the present disclosure, for example, the cutting step may be performed to adjust a form of a bottom surface that is not a stepped bottom surface.

Favorably, the cutting step is performed after the rolling step S121 and before the change step S122. As a result, the rolled body 16 is cut in a state in which the core 14 is situated in a portion corresponding to a central axis of the rolled body 16. Thus, the rolled body 16 is not easily deformed when being cut, and this makes it possible to easily obtain a rolled body having a desired cross-sectional surface. This matter is described below with reference to FIGS. 13 and 14.

FIG. 13 schematically illustrates a rolled body cut when a core is not situated in a portion corresponding to a central axis of the rolled body. As illustrated in the figure, when a rolled body R1 including no core in a portion corresponding to a central axis of the rolled body R1 is cut using a blade of a cutter C, the rolled body R1 is pressed upon cutting since the rolled body R1 is flexible and hollow. As a result, an opening made by cutting and situated at an end of the rolled body R1 is not horizontal.

FIG. 14 schematically illustrates a rolled body cut when a core is situated in a portion corresponding to a central axis of the rolled body. As illustrated in the figure, when a rolled body R2 including a core situated in a portion corresponding to a central axis of the rolled body R2 is cut using the blade of the cutter C, the rolled body R2 is not easily pressed upon cutting since the core is situated in a center portion of the rolled body R2. As a result, an opening made by cutting and situated at an end of the rolled body R2 is horizontal.

When the cutting step described above is performed in a state in which a core is situated inside of a rolled body, that is, when, for example, the cutting step is performed after the rolling step S121 and before the change step S122, as described above, this makes it possible to obtain a rolled body of a good quality.

Favorably, the cutting is performed using an ultrasonic waves cutter. The ultrasonic waves are suitable for cutting a flexible material, and are suitable for cutting a rolled body including an elastomer layer. Further, favorably, a material of a core is paper or a plastic material in order to prevent an edge of a cutter from being chipped.

### 1.3.3 Modularization Step

In the modularization step, the rolled body is modularized to form an rDEA. In other words, it is sufficient if the rolled body is configured to serve as a DEA module in the modularization step, and this step may be designed as appropriate by those skilled in the art.

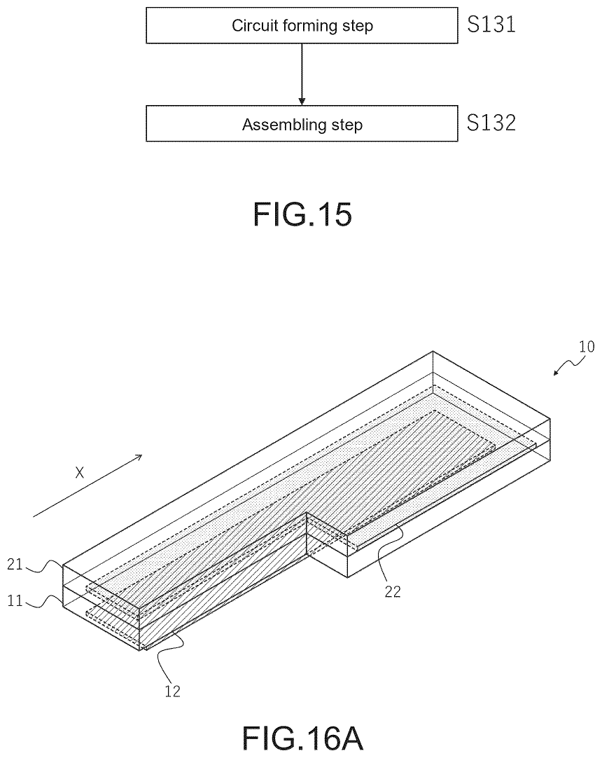

The modularization step may include a circuit forming step S131 to incorporate an electrode layer of the rolled body into a specified circuit, and an assembling step S132 to assemble the rolled body into a specified DEA module, as indicated by, for example, a flowchart in FIG. 15.

In the circuit forming step S131, for example, an electrode layer included in a rolled body is electrically connected to a circuit.

In the present disclosure, an electrode layer exposed from a stepped bottom surface may be connected to an electrode of the circuit, as described later. For example, the electrode of the circuit may be incorporated into a member that is fitted into the stepped bottom surface. The member is, for example, a cap portion, and this will be described separately later. In the assembling step S132, the rolled body may be incorporated into any housing for the user's convenience.

Accordingly, an rDEA may be manufactured.

1.4 rDEA According to Present Disclosure

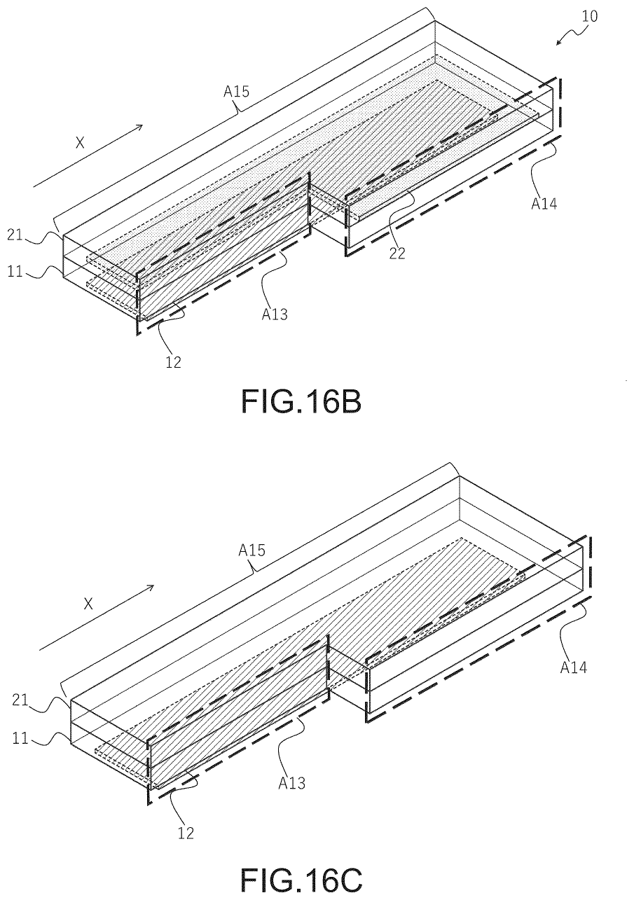

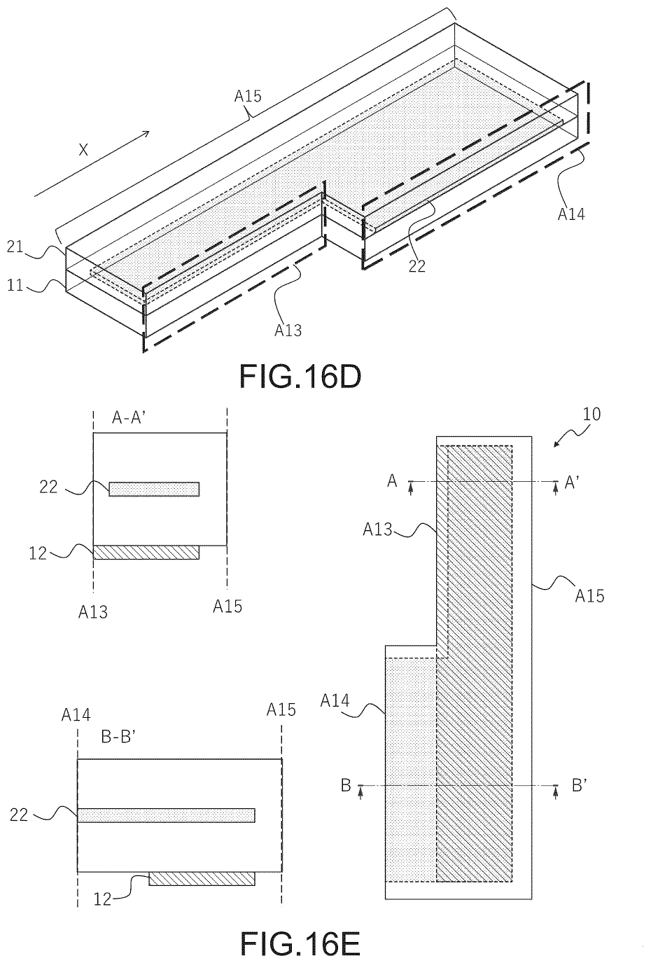

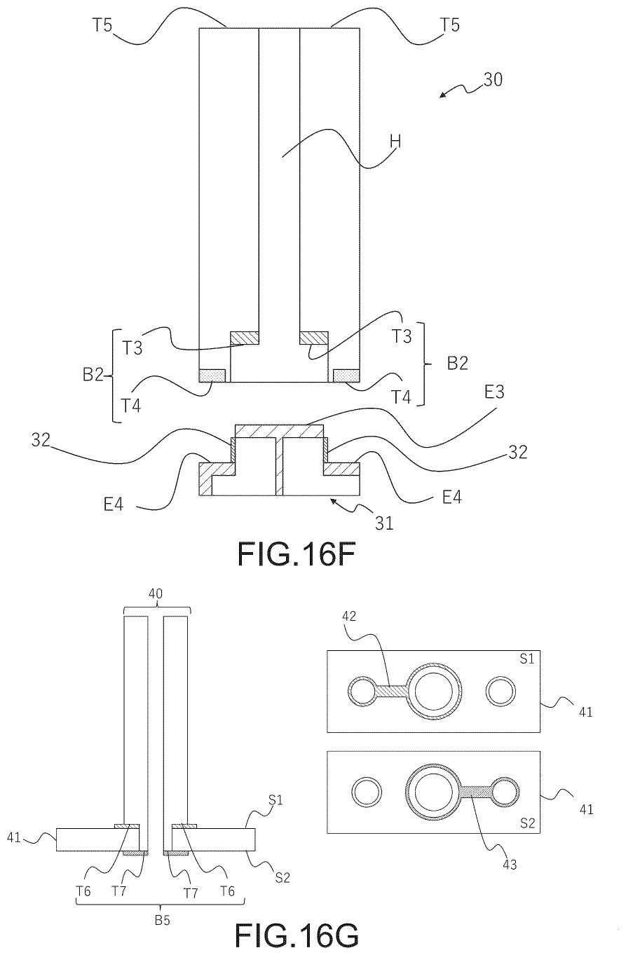

An rDEA according to the present disclosure includes a rolled body of a laminate obtained by stacking an electrode layer and a dielectric elastomer layer. The rolled body includes at least one stepped bottom surface. An example of a basic configuration of the rDEA according to the present disclosure is described with reference to FIGS. 16A to 16F.

As described in 1.3 above, a rolled body included in the rDEA is obtained by rolling a laminate obtained by stacking an electrode layer and a dielectric elastomer layer. Adjustment is performed to form the rolled laminate into a specified shape, and, as a result, the rolled body obtained by the rolling includes a stepped bottom surface. FIG. 16A is a schematic perspective view of an example of a laminate of which a shape is adjusted.

A laminate 10 illustrated in the figure has a lamination structure in which an electrode layer and a dielectric elastomer layer are stacked alternately. More specifically, the laminate 10 has a structure in which a first electrode layer 12, a first dielectric elastomer layer 11, a second electrode layer 22, and a second dielectric elastomer layer 21 are stacked in this order. The laminate is rolled in a direction indicated by an arrow X in the figure. The rolling may be performed using a core, as described in the rolled body forming step described in 1.3 above. However, the rolling may be performed without using a core.

As illustrated in FIG. 16B, the laminate 10 is rolled in the direction of the arrow X. As used herein, the direction in which a laminate is rolled is also referred to as a rolling direction. The laminate 10 is rolled in the rolling direction to form a rolled body in a tube form (especially in a cylindrical form) or in a pillar form (in a columnar form). FIG. 16F schematically illustrates a cross section of the rolled body in a plane including an axis of the cylinder of the rolled body.

One of bottom surfaces of the rolled body is a stepped bottom surface that includes a step T13 and a step T14, where the step T13 is formed of a lamination cross-sectional surface (also referred to as a surface A13) indicated by reference numeral A13, and the step T14 is formed of a lamination cross-sectional surface (also referred to as a surface A14) indicated by reference numeral A14.

Another of the bottom surfaces of the rolled body is a non-stepped bottom surface that only includes a step T15 that is formed of a lamination cross-sectional surface (also referred to as a surface A15) on a side indicated by reference numeral A15.

In addition to the first dielectric elastomer layer 11 and the second dielectric elastomer layer 21, the first electrode layer 12 is exposed from the surface A13 forming the stepped bottom surface, whereas the second electrode layer 22 is not exposed therefrom. As a result, in addition to the first dielectric elastomer layer 11 and the second dielectric elastomer layer 21, the first electrode layer 12 is exposed from the step T13 formed by the surface A13, whereas the second electrode layer 22 is not exposed therefrom, the step T13 being one of two steps included in the stepped bottom surface.

In addition to the first dielectric elastomer layer 11 and the second dielectric elastomer layer 21, the second electrode layer 22 is exposed from the surface A14 forming the stepped bottom surface, whereas the first electrode layer 12 is not exposed therefrom. As a result, in addition to the first dielectric elastomer layer 11 and the second dielectric elastomer layer 21, the second electrode layer 22 is exposed from the step T14 formed by the surface A14, whereas the first electrode layer 12 is not exposed therefrom, the step T14 being one of the two steps included in the stepped bottom surface.

In order to better understand about an exposure state of the first electrode layer 12, a structure of the laminate is described with reference to FIG. 16C. FIG. 16C is a perspective view of the laminate 10 illustrated in FIG. 16B, where the second electrode layer 22 from among structural elements of the laminate 10 has been omitted.

A hatched layer in the figure is the first electrode layer 12. The first electrode layer 12 is provided on one of principal surfaces (a principal surface opposite to a principal surface on which the second electrode layer is stacked) of the first dielectric elastomer layer 11.

As illustrated in the figure, the first electrode layer 12 has a configuration in a lamination surface such that the first electrode layer 12 is exposed from the surface A13, but is not exposed from the surface A14. As a result, the first electrode layer 12 is exposed from the step T13, which is one of the steps of the stepped bottom surface of the rolled body, and is not exposed from the step T14, which is another of the steps of the stepped bottom surface.

Further, the first electrode layer 12 has a configuration in a lamination surface such that the first electrode layer 12 is not exposed from the surface A15, as illustrated in the figure. As a result, the first electrode layer 12 is not exposed from a non-stepped bottom surface T15 of the formed rolled body.

In order to better understand about an exposure state of the second electrode layer 22, the structure of the laminate is described with reference to FIG. 16D. FIG. 16D is a perspective view of the laminate 10 illustrated in FIG. 16B, where only the first electrode layer 12 from among the structural elements of the laminate 10 is not depicted.

A layer indicated by dots in the figure is the second electrode layer 22. The second electrode layer 22 is a layer situated between the first dielectric elastomer layer 11 and the second dielectric elastomer layer 21.

As illustrated in the figure, the second electrode layer 22 has a configuration in the lamination surface such that the second electrode layer 22 is not exposed from the surface A13, but is exposed from the surface A14. As a result, the second electrode layer 22 is exposed from the step T14, which is one of the steps of the stepped bottom surface of the formed rolled body, and is not exposed from the step T13, which is another of the steps of the stepped bottom surface.

Further, the second electrode layer 22 has a configuration in the lamination surface such that the second electrode layer 22 is not exposed from the surface A15, as illustrated in the figure. As a result, the second electrode layer 22 is not exposed from the non-stepped bottom surface T15 of the formed rolled body.

In order to better understand about the lamination structure of the laminate 10, the laminate is described with reference to FIG. 16E. FIG. 16E illustrates, on the right, a top view of the laminate 10.

The figure schematically illustrates, on the upper left, a cross section A-A′ (a cross section that passes through the surfaces A13 and A15) of the laminate 10. In the cross section A-A′, the first electrode layer 12 is exposed from the surface A13, but the second electrode layer 22 is not exposed from the surface A13, as illustrated in the schematic diagram. Further, in the cross section A-A′, neither the first electrode layer 12 nor the second electrode layer 22 is exposed from the surface A15.

The figure schematically illustrates, on the lower left, a cross section B-B′ (a cross section that passes through the surfaces A14 and A15) of the laminate 1. In the cross section B-B′, the first electrode layer 12 is not exposed from the surface A14, but the second electrode layer 22 is exposed from the surface A14, as illustrated in the schematic diagram. Further, in the cross section B-B′, neither the first electrode layer 12 nor the second electrode layer 22 is exposed from the surface A15.

Note that each of the cross section A-A′ and the cross section B-B′ has a portion in which the second electrode layer 22 is not situated between the first dielectric elastomer layer 11 and the second dielectric elastomer layer 21 due to a pattern of the second electrode layer 22. The first dielectric elastomer layer 11 and the second dielectric elastomer layer 21 are directly in contact with each other in each of the portions.

Due to the above-described structure of the laminate (especially the configurations of the first electrode layer 12 and the second electrode layer 22 in the lamination surface, and structures of cross sections of the first electrode layer 12 and the second electrode layer 22), only one of electrode layers is exposed from one of steps of a stepped bottom surface of a rolled body, and only another of the electrode layers is exposed from another of the steps.

FIG. 16F is a schematic diagram of a cross section of the rolled body described above.

Note that, in order to better understand about exposure states of electrodes from bottom surfaces, a lamination structure is omitted in the schematic diagram of the cross section.

Further, in the schematic diagram of the cross section, hatching or dots exist all over the surfaces of the steps T3 and T4. In other words, the surfaces of these steps look as if all of the surfaces were formed of electrode layers only. This is merely representation for better understanding that electrode layers are exposed therefrom, and actual states of the surfaces of the steps are not reflected in the schematic diagram. Actually, first and second dielectric elastomer layers are exposed from these steps, and further, a first or second electrode layer is exposed between the elastomer layers, each of the first and second electrode layers being much thinner than each of the elastomer layers.

As illustrated in the figure, a rolled body 30 is in a cylindrical form. In other words, the rolled body 30 includes a hollow portion H in a substantially columnar form, where an axis of the column is the same as a rolling axis of the rolled body. As described in 1.3 above, the cylindrical form may be created by obtaining a rolled body by the laminate 10 being rolled around a core.

In the present disclosure, a rolled body that does not include the hollow portion H may be formed, that is, the rolled body may be in a columnar form.

Further, the figure illustrates a rolled body in a cylindrical form, but the rolled body may be in the form of a polygonal tube (such as in the form of a rectangular tube) or in the form of a polygonal pillar (such as in the form of a rectangular pillar). These forms may be created using shape adjustment performed by applying a specified pressure after rolling, or may be created during rolling.

The rolled body 30 includes a stepped bottom surface B2 and a non-stepped bottom surface T5, the stepped bottom surface B2 including steps T3 and T4.

The first electrode layer 12 is exposed from the step T3, whereas the second electrode layer 22 is not exposed from the step T3. The first dielectric elastomer layer 11 and the second dielectric elastomer layer 21 are also exposed from the step T3, and the first electrode layer 12 may be exposed to be situated between the first dielectric elastomer layer 11 and the second dielectric elastomer layer 21.

The second electrode layer 22 is exposed from the step T4, whereas the first electrode layer 12 is not exposed from the step T4. The first dielectric elastomer layer 11 and the second dielectric elastomer layer 21 are also exposed from the step T4, and the second electrode layer 22 may be exposed to be situated between the first dielectric elastomer layer 11 and the second dielectric elastomer layer 21.

Neither the first electrode layer 12 nor the second electrode layer 22 is exposed from the non-stepped bottom surface T5. The first dielectric elastomer layer 11 and the second dielectric elastomer layer 21 are exposed from the non-stepped bottom surface T15.

A rolled body including such a stepped bottom surface (a concave stepped bottom surface) is suitable for, for example, preventing a short circuit from being caused between electrodes. In other words, a short circuit caused between electrode layers can be prevented since the electrode layers are respectively exposed from different steps.

Further, it is necessary that the first electrode layer 12 and second electrode layer 22 being included in the rolled body 30 be electrically connected to a circuit, in order to operate an rDEA that includes the rolled body 30. In order to make the connection with a circuit, a cap portion 31 into which an electrode is incorporated may be used. The cap portion 31 with an electrode has a convex shape, as illustrated in the figure. The convex shape enables the cap portion 31 with an electrode to be fitted into the stepped bottom surface.

An electrode connected to the first electrode layer 12 is provided to a step E3 of the convex shape.

An electrode connected to the second electrode layer 22 is provided to a step E4 of the convex shape.

When two electrodes provided to the cap portion 31 are respectively provided to different steps, as described above, this makes it possible to prevent a short circuit between electrodes with more certainty.

An insulating material 32 is provided to a region situated between the steps E3 and E4 of the convex shape. This makes it possible to prevent a short circuit between two electrode layers (or a short circuit between two electrodes) with more certainty. The insulating material 32 may be favorably an insulating bonding agent. The insulating bonding agent enables the rolled body 30 and the cap portion 31 to be connected to each other more strongly.

Further, an example of the configuration of the rDEA of which a rolled body is connected to a cap portion has been described in FIG. 16F described above. However, the rDEA according to the present disclosure may have a configuration in which a rolled body is incorporated into a substrate. An example of such a configuration is described with reference to FIG. 16G.

The figure schematically illustrates a cross section of a rolled body 40 according to the present disclosure and a substrate 41, where the rolled body 40 is incorporated into the substrate 41. The laminate 10 described above with reference to FIG. 16A is rolled in a direction opposite to the X direction in the figure. Accordingly, the rolled body 40 is formed. In other words, when the rolled body 40 is rolled as described above, the rolled body 40 including a stepped bottom surface B5 in which an inner-diameter-side step T7 protrudes with respect to an outer-diameter-side step T6 is formed.

As illustrated in FIGS. 16F and 16G, the rolled body may include, in one stepped bottom surface, two steps that are an inner-diameter-side step and an outer-peripheral-side step, and may have a structure in which the inner-diameter-side step is recessed or protrudes with respect to the outer-peripheral-side step.

As illustrated, for example, on the right in the figure, the rolled body 40 may be incorporated such that the stepped bottom surface B5 is inserted into a hole in the substrate 41 on which a circuit is formed in advance.

An electrode 42 is provided to a surface S1 that is one of two surfaces of the substrate 41, and the electrode 42 is electrically connected to an electrode layer that is exposed from the step T6.

An electrode 43 is provided to a surface S2, and the electrode 43 is electrically connected to an electrode layer that is exposed from the step T7.

The electrode layers of the rolled body 40 are connected to the circuit through the electrodes 42 and 43. The rolled body 40 may be connected to the circuit, as described above, to form an rDEA. A stepped bottom surface is also suitable for incorporating a rolled body into a substrate, and may be used to, for example, fit the rolled body into the substrate. Further, when electrode layers respectively exposed from steps of a stepped bottom surface are respectively connected to electrodes respectively provided to a back surface and a front surface of the substrate, as described above, this also makes it possible to prevent a short circuit from being caused.

As described above, the rDEA according to the present disclosure is characterized in that a rolled body included in the rDEA includes a stepped bottom surface. An example of the configuration of the rDEA (especially a rolled body) is further described below.

1.4.1 First Example (Rolled Body Including Stepped Bottom Surface with Two Steps and Method for Manufacturing Rolled Body)

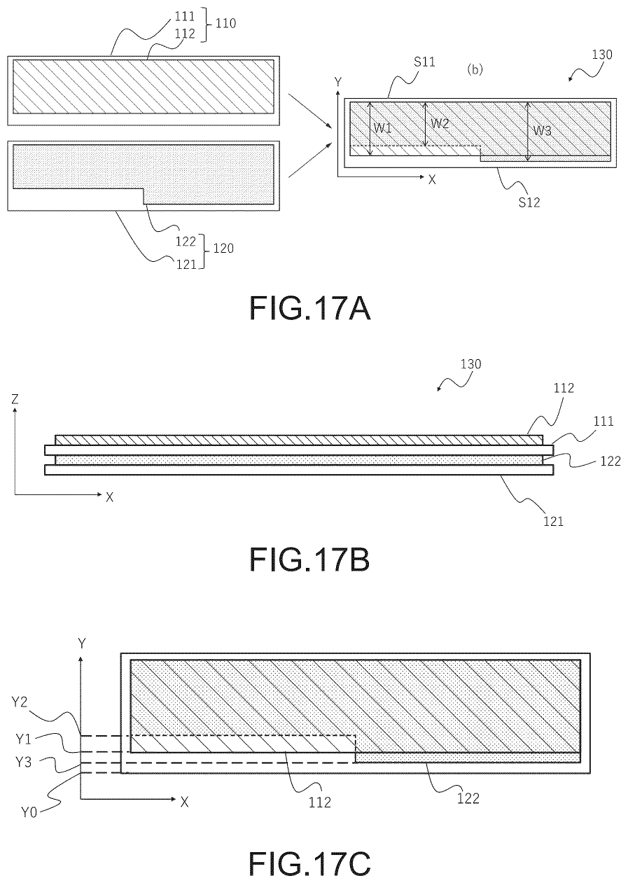

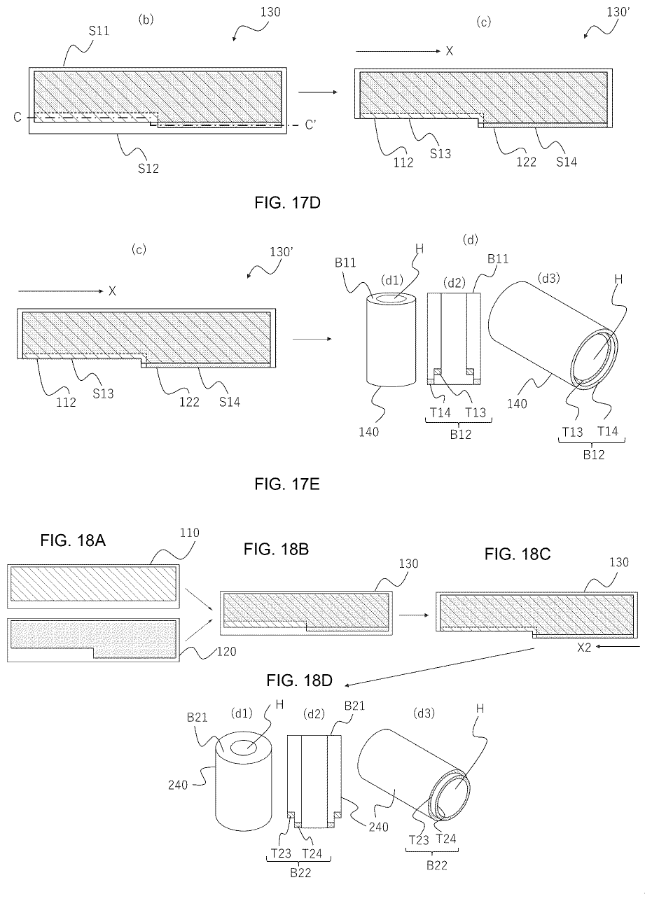

The rDEA according to the present disclosure includes a rolled body that includes at least one stepped bottom surface. The rolled body may be manufactured by, for example, adjusting a structure of a laminate rolled in the rolled body forming step included in the manufacturing method described above. A rolled body including a stepped bottom surface and a method for manufacturing the rolled body are described below with reference to FIGS. 17A to 17E.

As illustrated in (a) of FIG. 17A, a first laminate 110 is provided that includes a first elastomer layer 111 and a first electrode layer 112 stacked on the first elastomer layer.

Further, a second laminate 120 is provided that includes a second elastomer layer 121 and a second electrode layer 122 stacked on the second elastomer layer.

The first electrode layer 112 and the second electrode layer 122 are patterned to be respectively exposed from different steps of a stepped bottom surface of a rolled body described later.

The first laminate 110 is stacked on the second laminate 120 to obtain a laminate 130 illustrated in (b) of the figure.

In the figure, an X axis is an axis parallel to a direction in which a laminate described later is rolled, and is also referred to as a rolling direction X. A Y axis is an axis parallel to an axis of a rolled body, and is also referred to as an axial direction Y.

FIG. 17B schematically illustrates a cross section of the laminate 130. As illustrated in the figure, the laminate 130 has a lamination structure in which the second elastomer layer 121, the second electrode layer 122, the first elastomer layer 111, and the first electrode layer 112 are stacked in this order. In the figure, the X axis is an axis parallel to a direction in which a laminate is rolled, as described above. A Z axis is an axis vertical to the X axis and the Y axis.

As illustrated in FIG. 17A, an external shape of the laminate 130 has a side portion S11 and a side portion S12. Neither the first electrode layer 112 nor the second electrode layer 122 is exposed from the side portion S11. Further, neither the first electrode layer 112 nor the second electrode layer 122 is exposed from the side portion S12.

Here, a pattern (also referred to as a printing pattern or an application pattern) of the first electrode layer 112 is different from a pattern of the second electrode layer 122.

The difference in pattern between electrode layers is described below with reference to (b) of FIG. 17A and FIG. 17C.

When side portions of the two electrode layers that are situated on the side of a non-stepped bottom surface (that is, on the side of the side portion S11) coincide, the difference in pattern between the two electrode layers can be considered a difference regarding the width of an electrode layer in a Y-axis direction.

The two electrode layers may be formed such that there is at least one region in which the two electrode layers have different widths in the Y-axis direction, and favorably the two electrode layers may be formed such that there are at least two regions in which the two electrode layers have different widths in the Y-axis direction. Particularly favorably, the two electrode layers are patterned such that there are at least one region in which one of electrode layers has a larger width in the Y-axis direction than another of the electrode layers, and at least one region in which the one of the electrode layers has a smaller width in the Y-axis direction than the other of the electrode layers.

As illustrated in, for example, (b) of FIG. 17A, the width of the first electrode layer 112 in the Y-axis direction is substantially constant in the rolling direction X, and is represented by W1.

On the other hand, the second electrode layer 122 includes a region in which the width of the second electrode layer 122 in the axial direction Y is represented by W2, and a region in which the width of the second electrode layer 122 in the axial direction is represented by W3.

Here, W1, W2, and W3 have the following relationship: W2<W1<W3. In other words, the width W1 of the first electrode layer 112 in the Y-axis direction is larger than the width W2 of the second electrode layer 122 in the Y-axis direction, as seen on the left in (b) of the figure, and the width W1 of the first electrode layer 112 in the Y-axis direction is smaller than the width W3 of the second electrode layer 122 in the Y-axis direction, as seen on the right in (b) of the figure. The first electrode layer and the second electrode layer are formed such that there are a region in which W2<W1 and a region in which W1<W3, as described above. This makes it easy to form, in a stepped bottom surface of a rolled body, one step from which only one electrode layer is exposed.

Alternatively, the difference in pattern between the two electrode layers may be considered a difference regarding a position of a side portion of each electrode layer in the Y-axis direction, where the side portion is parallel to an X-axis direction (in particular, the side portion is a side portion on the side of a stepped bottom surface).

As illustrated in, for example, FIG. 17C, the first electrode layer 112 has a shape that has a side portion at a position Y1 in the Y-axis direction when the first electrode layer 112 is incorporated into the laminate 130.

On the other hand, the second electrode layer 122 has a shape that has a side portion at a position Y2 in the Y-axis direction and another side portion at a position Y3 in the axial direction when the second electrode layer 122 is incorporated into the laminate 130. Here, Y1, Y2, and Y3 have the following relationship when a position of a side portion of an external shape of the laminate 130 is represented by Y0, the side portion being one of two side portions of the external shape that forms a stepped bottom surface, each of the two side portions being parallel to the X-axis direction: (distance between Y2 and Y0)>(distance between Y1 and Y0)>(distance between Y3 and Y0). The first electrode layer and the second electrode layer are formed such that there is such a relationship. This makes it easy to form, in a stepped bottom surface of a rolled body, one step from which only one electrode layer is exposed.

Next, the external shape of the laminate 130 is adjusted, as illustrated in FIG. 17D. Specifically, the adjustment of the external shape is performed such that a stepped bottom surface is formed when a laminate 130′ obtained by the adjustment of the external shape is rolled. More specifically, the laminate 130 is cut along a dot-dash cutting line C-C′ illustrated in (b) of the figure. This results in partially cutting the side portion S12 of the laminate 130 to form side portions S13 and S14 that are parallel to the X-axis direction, as illustrated in (c) of the figure.

Due to the cutting, the first electrode layer 112 is exposed from a cross-sectional surface including the side portion S13, and the second electrode layer 122 is exposed from a cross-sectional surface including the side portion S14.

As described above, the laminate 130 is partially cut to form the side portions S13 and S14, and the first electrode layer 112 and the second electrode layer 122 are respectively exposed from the cross-sectional surface including the side portion S13 and the cross-sectional surface including the side portion S14.

After the external shape is adjusted, the laminate 130′ is rolled in the rolling direction X, as illustrated in (c) of FIG. 17E, to obtain a rolled body. The rolling may be performed using a core, as described above. Note that the laminate 130′ may be rolled without using a core.

After the core is removed, a rolled body 140 as illustrated in (d) of the figure is obtained. In the figure, (d1) is a schematic perspective view illustrating a form of a non-stepped bottom surface of the rolled body 140. (d2) schematically illustrates a cross section of the rolled body 140 along a plane parallel to the rolling axis. (d3) is a schematic perspective view illustrating a form of a stepped bottom surface of the rolled body 140.

The rolled body 140 includes two bottom surfaces B11 and B12.

The bottom surface B11 may be formed of a lamination cross-sectional surface that includes the side portion S11. The bottom surface B11 may be a non-stepped bottom surface. The bottom surface B11 is formed of the first and second elastomer layers 111 and 121. Neither of the electrode layers has to be exposed from the bottom surface B11. A center portion of the bottom surface B11 corresponds to the hollow portion H created by removing the core.

Note that the bottom surface B11 may be a bottom surface formed by cutting performed in the cutting step described above. In this case, the cutting may be performed such that neither of the electrode layers is exposed from the bottom surface B11.

In the present disclosure, a non-stepped bottom surface of a rolled body may be formed of a lamination cross-sectional surface of at least one dielectric elastomer layer used to form the rolled body, as described above.

The bottom surface B12 is a stepped bottom surface and includes the steps T13 and T14, where the step T13 is formed of the cross-sectional surface including the side portion S13, and the step T14 is formed of the cross-sectional surface including the side portion S14. As illustrated in (d2) and (d3) in the figure, the step T14 further protrudes toward the stepped bottom surface of the cylinder than the step T13. Further, the steps T13 and T14 are formed concentrically about an axis of the rolled body, where the step T14 is situated on an outer peripheral side of the rolled body, and the step T13 is situated on the inner-diameter side of the rolled body.

Furthermore, a center portion of the bottom surface B12 corresponds to the hollow portion H created by removing the core.

The first electrode layer 112 is exposed from the step T13. More specifically, in addition to the first and second elastomer layers 111 and 121, the first electrode layer 112 is exposed from the step T13.

Note that, in (d2) and (d3) in the figure, the entirety of the surface of the step T13 is hatched. In other words, the surface of the step T13 looks as if all of the surface were formed of the first electrode layer 112 only. This is merely representation for better understanding that the first electrode layer 112 is exposed therefrom, and an actual state of the surface of the step T13 is not reflected in (d2) or (d3). Actually, the first and second elastomer layers 111 and 121 are exposed from the step T13, and further, the first electrode layer 112 much thinner than each of the elastomer layers is situated between the elastomer layers to be exposed from the surface of the step T13.

The second electrode layer 122 is exposed from the step T14. More specifically, in addition to the first and second elastomer layers 111 and 121, the second electrode layer 122 is exposed from the step T14.

Note that, in (d2) and (d3) in the figure, the entirety of the surface of the step T14 is indicated by dots. In other words, the surface of the step T14 looks as if all of the surface were formed of the second electrode layer 122 only. However, actually, the first and second elastomer layers 111 and 121 are exposed from the step T14, and further, the second electrode layer 122 much thinner than each of the elastomer layers is situated between the elastomer layers to be exposed from the surface of the step T14, as in the case of the step T13.

Further, the step T14 protrudes with respect to the step T13, as described above. This makes it possible to prevent a short circuit from being caused between the first electrode layer 112 exposed from the step T13 and the second electrode layer 122 exposed from the step T14.

Furthermore, the stepped bottom surface is suitable for more strongly fitting a cap portion into the rolled body, as described above.

1.4.2 Second Example (Rolled Body Including Stepped Bottom Surface with Two Steps and Method for Manufacturing Rolled Body)

The example in which a rolled body that includes a stepped bottom surface of which an outer-peripheral-side step protrudes (that is, of which an inner-peripheral-side step is recessed) has been described in the first example above. In the present disclosure, the outer-peripheral-side step may be recessed (that is, the inner-peripheral-side step may protrude). A rolled body including a stepped bottom surface and a method for manufacturing the rolled body are described below with reference to FIG. 18.

An example illustrated in (a) to (c) of FIG. 18 can be described as in the case of the description made with reference to FIGS. 17A to 17D in the first example above, and the description made in the first example also applies to this example. In other words, the laminate 130′ illustrated in FIG. 18 and obtained by the adjustment of the external shape is similar to the laminate 130′ illustrated in FIG. 17D and obtained by the adjustment of the external shape.

After adjustment of the external shape, the laminate 130 is rolled in a direction indicated by reference numeral X2 to obtain a rolled body. In other words, the laminate 130′ is rolled in the direction opposite to the rolling direction X indicated in the first example above.

The rolling may be performed using a core, as in the case of the first example above. Note that the laminate 130′ may be rolled without using a core.

After the core is removed, a rolled body 240 as illustrated in (d) of the figure is obtained. In the figure, (d1) is a schematic perspective view illustrating a form of a non-stepped bottom surface of the rolled body 240. (d2) schematically illustrates a cross section of the rolled body 240 along a plane parallel to a rolling axis. (d3) is a schematic perspective view illustrating a form of a stepped bottom surface of the rolled body 240.

The rolled body 240 includes two bottom surfaces B21 and B22.

The bottom surface B21 may be formed of a lamination cross-sectional surface that includes the side portion S11. The bottom surface B21 may be a non-stepped bottom surface. The bottom surface B21 is formed of the first and second elastomer layers 111 and 121. Neither of the electrode layers has to be exposed from the bottom surface B21.

A center portion of the bottom surface B21 corresponds to the hollow portion H created by removing the core.

In the present disclosure, a non-stepped bottom surface of a rolled body may be formed of a lamination cross-sectional surface of at least one dielectric elastomer layer used to form the rolled body, as described above.

The bottom surface B22 is a stepped bottom surface and includes steps T23 and T24, where the step T23 is formed of the cross-sectional surface including the side portion S13, and the step T24 is formed of the cross-sectional surface including the side portion S14. As illustrated in (d2) and (d3) in the figure, the step T24 further protrudes toward the stepped bottom surface of the cylinder than the step T23. Further, the steps T23 and T24 are formed concentrically about an axis of the rolled body, where the step T24 is situated on an inner-diameter side of the rolled body, and the step T23 is situated on an outer peripheral side of the rolled body.

Furthermore, a center portion of the bottom surface B22 corresponds to the hollow portion H created by removing the core.

The first electrode layer 112 is exposed from the step T23. More specifically, in addition to the first and second elastomer layers 111 and 121, the first electrode layer 112 is exposed from the step T23.

Note that, in (d2) and (d3) in the figure, the entirety of the surface of the step T23 is hatched. In other words, the surface of the step T23 looks as if all of the surface were formed of the first electrode layer 112 only. However, actually, the first and second elastomer layers 111 and 121 are exposed from the step T23, and further, the first electrode layer 112 much thinner than each of the elastomer layers is situated between the elastomer layers to be exposed from the surface of the step T23, as described in the first example above.

The second electrode layer 122 is exposed from the step T24. More specifically, in addition to the first and second elastomer layers 111 and 121, the second electrode layer 122 is exposed from the step T24.

Note that, in (d2) and (d3) in the figure, the entirety of the surface of the step T24 is indicated by dots. However, actually, the first and second elastomer layers 111 and 121 are exposed from the step T24, and further, the second electrode layer 122 much thinner than each of the elastomer layers is situated between the elastomer layers to be exposed from the surface of the step T24, as described in the first example above.

Further, the step T24 further protrudes toward a stepped bottom surface than the step T23, as described above. This makes it possible to prevent a short circuit from being caused between the first electrode layer 112 exposed from the step T23 and the second electrode layer 122 exposed from the step T24.

Further, different stepped bottom surfaces can be formed just by changing a direction in which the laminate 130′ is rolled, as illustrated in the first and second examples.

1.4.3 Third Example (Rolled Body Including Stepped Bottom Surface with Three Steps and Method for Manufacturing Rolled Body)

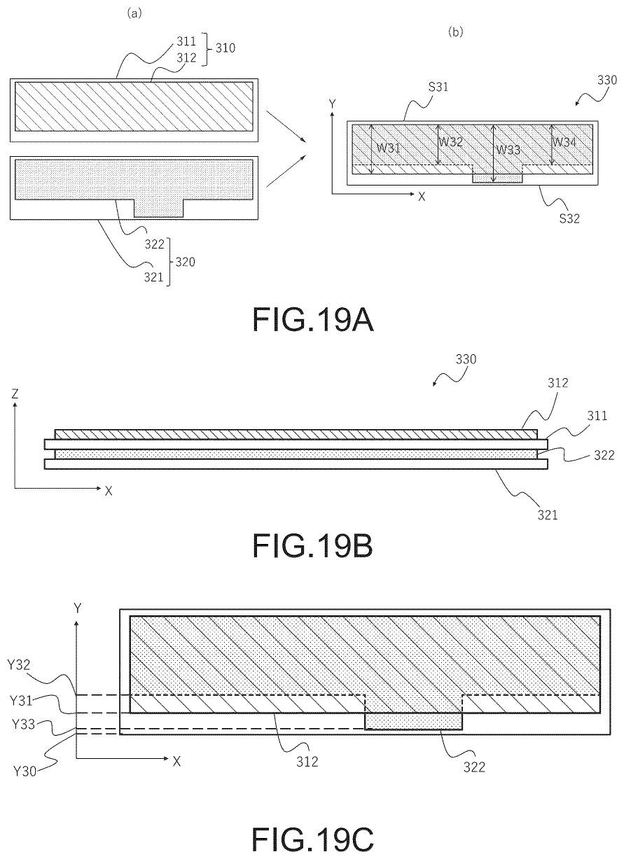

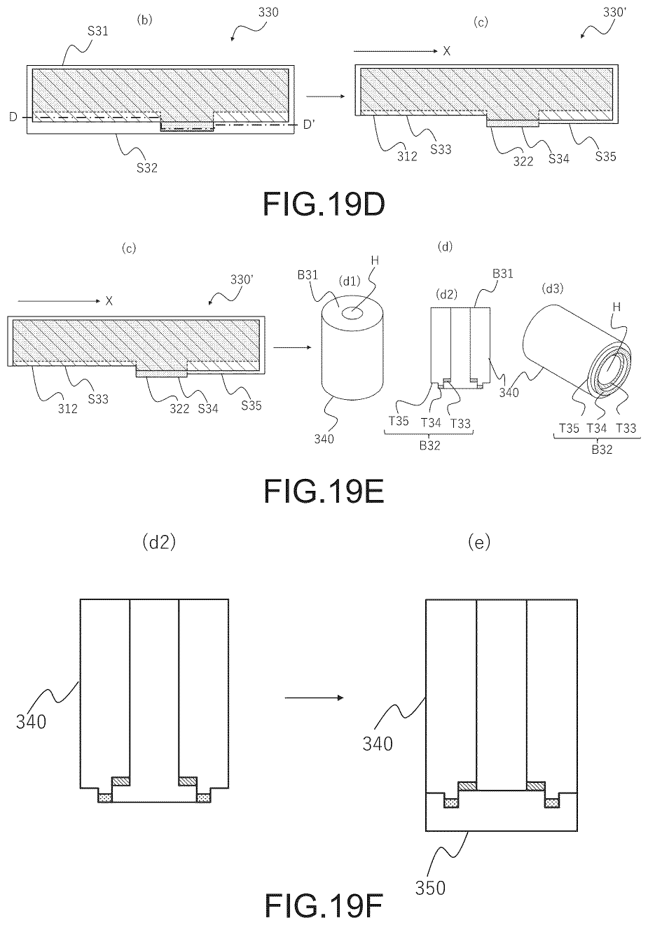

The method for manufacturing a rolled body including a stepped bottom surface with two steps has been described in the first and second examples above. In the present disclosure, the number of stepped bottom surfaces is not limited to two, and may be three or more. A rolled body including a stepped bottom surface with three steps and a method for manufacturing the rolled body are described below with reference to FIG. 19.

As illustrated in (a) of the figure, a first laminate 310 is provided that includes a first elastomer layer 311 and a first electrode layer 312 stacked on the first elastomer layer.

Further, a second laminate 320 is provided that includes a second elastomer layer 321 and a second electrode layer 322 stacked on the second elastomer layer.

Here, a pattern of the first electrode layer 312 is different from a pattern of the second electrode layer 322.

More specifically, the first electrode layer 312 and the second electrode layer 322 are patterned to be respectively exposed from different steps of a stepped bottom surface of a rolled body.

The first laminate 310 is stacked on the second laminate 320 to obtain a laminate 330 illustrated in (b) of the figure.

In the figure, an X axis is an axis parallel to a direction in which a laminate described later is rolled, and is also referred to as a rolling direction X. A Y axis is an axis parallel to an axis of a rolled body, and is also referred to as an axial direction Y.

FIG. 19B schematically illustrates a cross section of the laminate 330. As illustrated in the figure, the laminate 330 has a lamination structure in which the second elastomer layer 321, the second electrode layer 322, the first elastomer layer 311, and the first electrode layer 312 are stacked in this order. In the figure, the X axis is an axis parallel to a direction in which a laminate is rolled, as described above. A Z axis is an axis vertical to the X axis and the Y axis.

As illustrated in FIG. 19A, an external shape of the laminate 330 has a side portion S31 and a side portion S32. Neither the first electrode layer 312 nor the second electrode layer 322 is exposed from the side portion S31. Further, neither the first electrode layer 312 nor the second electrode layer 322 is exposed from the side portion S32.

Here, the pattern (also referred to as a printing pattern or an application pattern) of the first electrode layer 312 is different from the pattern of the second electrode layer 322.

The difference in pattern between electrode layers is described below with reference to (b) of FIG. 19A and FIG. 19C.

When side portions of the two electrode layers that are situated on the side of a non-stepped bottom surface (that is, on the side of the side portion S31) coincide, the difference in pattern between the two electrode layers can be considered a difference regarding the width of an electrode layer in a Y-axis direction.

The two electrode layers may be formed such that there is at least one region in which the two electrode layers have different widths in the Y-axis direction, and favorably the two electrode layers may be formed such that there are at least two regions in which the two electrode layers have different widths in the Y-axis direction. Particularly favorably, the two electrode layers are patterned such that there are at least one region in which one of electrode layers has a larger width in the Y-axis direction than another of the electrode layers, and at least one region in which the one of the electrode layers has a smaller width in the Y-axis direction than the other of the electrode layers.

As illustrated in, for example, (b) of FIG. 19A, the width of the first electrode layer 312 in the Y-axis direction is substantially constant in an X-axis direction, and is represented by W31.

On the other hand, the second electrode layer 322 includes a region in which the width of the second electrode layer 322 in the Y-axis direction is represented by W32, a region in which the width of the second electrode layer 322 in the Y-axis direction is represented by W33, and a region in which the width of the second electrode layer 322 in the Y-axis direction is represented by W34. Here, W31, W32 (and W34), and W33 have the following relationship: W32<W31<W33 (W34<W31<W33). W32 may have the same value as W34, or W32 and W34 have different values. In other words, the first electrode layer and the second electrode layer are formed such that there are a region (a left region in (b) of the figure) in which W32<W31, a region (a right region in (b) of the figure) in which W34<W31, and a region (a middle region in (b) of the figure) in which W31<W33. This makes it easy to form, in a stepped bottom surface of a rolled body, one step from which only one electrode layer is exposed. This also makes it easy to form, in the stepped bottom surface, a step from which neither of the electrode layers is exposed.

Alternatively, the difference in pattern between the two electrode layers may be considered a difference regarding a position of a side portion of each electrode layer in the Y-axis direction, where the side portion is parallel to the X-axis direction (in particular, the side portion is a side portion on the side of a stepped bottom surface).

As illustrated in, for example, FIG. 19C, the first electrode layer 312 has a shape that has a side portion at a position Y31 in the Y-axis direction when the first electrode layer 312 is incorporated into the laminate 330.

On the other hand, the second electrode layer 322 has a shape that has two side portions at a position Y32 in the Y-axis direction and a side portion at a position Y33 in the axial direction when the second electrode layer 322 is incorporated into the laminate 330.

Here, Y31, Y32, and Y33 have the following relationship when a position of a side portion of an external shape of the laminate 330 is represented by Y30, the side portion being one of two side portions of the external shape that forms a stepped bottom surface, each of the two side portions being parallel to the X-axis direction: (distance between Y32 and Y30)>(distance between Y31 and Y30)>(distance between Y33 and Y30). The first electrode layer and the second electrode layer are formed such that there is such a relationship. This makes it easy to form, in a stepped bottom surface of a rolled body, one step from which only one electrode layer is exposed. This also makes it easy to form, in the stepped bottom surface, a step from which neither of the electrode layers is exposed.

Next, the external shape of the laminate 330 is adjusted, as illustrated in FIG. 19D. Specifically, the adjustment of the external shape is performed such that a stepped bottom surface is formed when the laminate 330 is rolled. More specifically, the laminate 330 is cut along a dot-dash cutting line D-D′ illustrated in (b) of the figure. This results in partially cutting the side portion S32 of the laminate 330 to form side portions S33, S34, and S35, as illustrated in (c) of the figure.

Due to the cutting, the first electrode layer 312 is exposed from a cross-sectional surface including the side portion S33, the second electrode layer 322 is exposed from a cross-sectional surface including the side portion S34, and neither of the electrode layers is exposed from a cross-sectional surface including the side portion S35.

As described above, the laminate 330 is partially cut to form the side portions S33, S34, and S35. The first electrode layer 312 and the second electrode layer 322 are respectively exposed from the cross-sectional surface including the side portion S33 and the cross-sectional surface including the side portion S34, and further, the cross-sectional surface including the side portion S35 and from which neither of the electrode layers is exposed, is formed.

After the external shape is adjusted, a laminate 330′ is rolled in the rolling direction X, as illustrated in (c) of FIG. 19E, to obtain a rolled body. The rolling may be performed using a core, as described above. Note that the laminate 330′ may be rolled without using a core.

After the core is removed, a rolled body 340 as illustrated in (d) of the figure is obtained. In the figure, (d1) is a schematic perspective view illustrating a form of a non-stepped bottom surface of the rolled body 340. (d2) schematically illustrates a cross section of the rolled body 340 along a plane parallel to the rolling axis. (d3) is a schematic perspective view illustrating a form of a stepped bottom surface of the rolled body 340.

The rolled body 340 includes two bottom surfaces B31 and B32.

The bottom surface B31 may be formed of a lamination cross-sectional surface that includes the side portion S31. The bottom surface B31 may be a non-stepped bottom surface. The bottom surface B31 is formed of the first and second elastomer layers 311 and 321. Neither of the electrode layers has to be exposed from the bottom surface B31.

A center portion of the bottom surface B31 corresponds to the hollow portion H created by removing the core.

Note that the bottom surface B31 may be a bottom surface formed by cutting performed in the cutting step described above. In this case, the cutting may be performed such that neither of the electrode layers is exposed from the bottom surface B31.

In the present disclosure, a non-stepped bottom surface of a rolled body may be formed of a lamination cross-sectional surface of at least one dielectric elastomer layer used to form the rolled body, as described above.

The bottom surface B32 is a stepped bottom surface and includes the steps T33, T34, and T35, where the step T33 is formed of the cross-sectional surface including the side portion S33, the step T34 is formed of the cross-sectional surface including the side portion S34, and the step T35 is formed of the cross-sectional surface including the side portion S35. As illustrated in (d2) and (d3) in the figure, the step T34 protrudes with respect to the steps T33 and T35. Further, the steps T33, T34, and T35 are formed concentrically about an axis of the rolled body, where the step T35 is situated on an outer peripheral side of the rolled body, the step T33 is situated on an inner-diameter side of the rolled body, and the step T34 is situated midway between the other two steps.

Furthermore, a center portion of the bottom surface B32 corresponds to the hollow portion H created by removing the core.

As described above, the rolled body according to the present disclosure may include, in one stepped bottom surface of the rolled body, three steps that are an inner-diameter-side step, an outer-peripheral-side step, and a midway step situated between the two steps. The midway step may protrude with respect to the inner-diameter-side step and the outer-peripheral-side step.

The first electrode layer 312 is exposed from the step T33. More specifically, in addition to the first and second elastomer layers 311 and 321, the first electrode layer 312 is exposed from the step T33.

Note that, in (d2) and (d3) in the figure, the entirety of the surface of the step T33 is hatched. However, actually, the first and second elastomer layers 311 and 321 are exposed from the step T33, and further, the first electrode layer 312 much thinner than each of the elastomer layers is situated between the elastomer layers to be exposed from the surface of the step T33, as described in the first example above.

The second electrode layer 322 is exposed from the step T34. More specifically, in addition to the first and second elastomer layers 311 and 321, the second electrode layer 322 is exposed from the step T34.

Note that, in (d2) and (d3) in the figure, the entirety of the surface of the step T34 is indicated by dots. However, actually, the first and second elastomer layers 311 and 321 are exposed from the step T34, and further, the second electrode layer 322 much thinner than each of the elastomer layers is situated between the elastomer layers to be exposed from the surface of the step T34, as described in the first example above.

Neither of the first and second electrode layers 312 and 322 is exposed from the step T35. More specifically, only the first and second elastomer layers 311 and 321 are exposed from the step T35, whereas neither of the electrode layers is exposed from the step T35.

Further, the step T34 protrudes with respect to the steps T33 and T35, as described above. This makes it possible to prevent a short circuit from being caused between the first electrode layer 312 exposed from the step T33 and the second electrode layer 322 exposed from the step T34.

Furthermore, neither of the electrode layers is exposed from the step T35, that is, only the dielectric elastomers are exposed from the step T35. Thus, when the step T35 from which no electrode layers are exposed covers around the steps T33 and T34 from which electrode layers are exposed, this makes it possible to prevent an electrode layer (or a circuit) of a rolled body from being brought into contact with an object that is situated outside of the rolled body, and thus to prevent a short circuit from being caused. When a step from which no electrode layers are exposed is situated on an outer periphery of a rolled body, as described above, this makes it possible to improve safety.

In the present disclosure, no electrodes may be exposed from an outer-peripheral-side step, as described above.

As illustrated in FIG. 19F, a cap portion 350 may be fitted into a stepped bottom surface B32, as described above. The form of a stepped bottom surface is helpful in more strongly coupling the rolled body to the cap portion 350.

Further, an electrode may be provided to the cap portion 350. The electrode may be configured to electrically connect a circuit included in an rDEA to the first and second electrode layers respectively exposed from the steps T33 and T34.

1.4.4 Fourth Example (Rolled Body Including Stepped Bottom Surface with Three Steps and Method for Manufacturing Rolled Body)

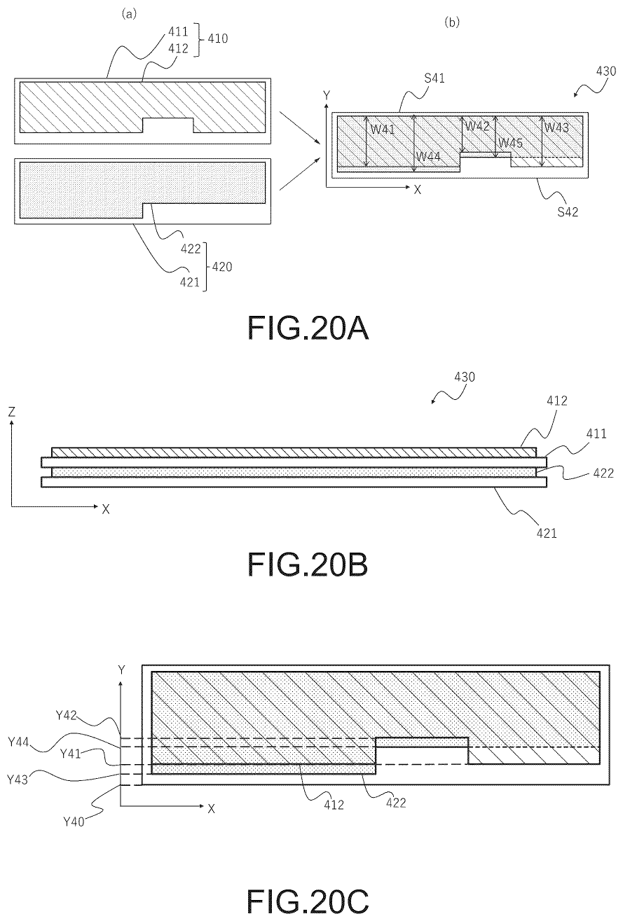

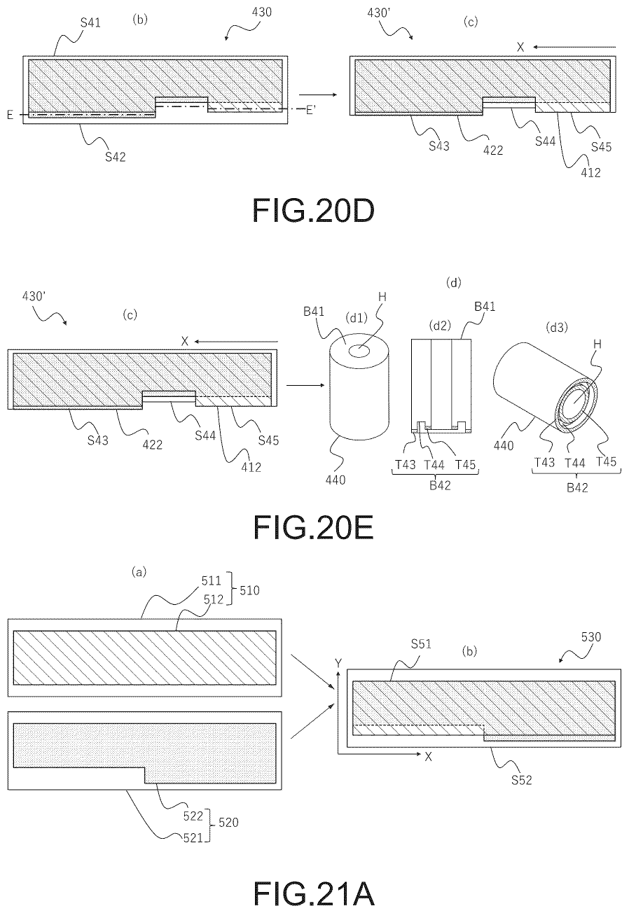

The rolled body including a stepped bottom surface with three steps and being described in the third example above has a structure in which a central step included in the three steps protrudes with respect to the other two steps. In the present disclosure, the structure regarding these three steps is not limited thereto, and, for example, the central step may be recessed, compared to the other two steps. A rolled body including a stepped bottom surface with three steps and a method for manufacturing the rolled body are described below with reference to FIGS. 20A to 20E.

As illustrated in (a) of FIG. 20A, a first laminate 410 is provided that includes a first elastomer layer 411 and a first electrode layer 412 stacked on the first elastomer layer.

Further, a second laminate 420 is provided that includes a second elastomer layer 421 and a second electrode layer 422 stacked on the second elastomer layer.

Here, a pattern of the first electrode layer 412 is different from a pattern of the second electrode layer 422.

More specifically, the first electrode layer 412 and the second electrode layer 422 are patterned to be respectively exposed from different steps of a stepped bottom surface of a rolled body.

The first laminate 410 is stacked on the second laminate 420 to obtain a laminate 430 illustrated in (b) of the figure.

In the figure, an X axis is an axis parallel to a direction in which a laminate described later is rolled. A Y axis is an axis parallel to an axis of a rolled body, and is also referred to as an axial direction Y.

FIG. 20B schematically illustrates a cross section of the laminate 430. As illustrated in the figure, the laminate 430 has a lamination structure in which the second elastomer layer 421, the second electrode layer 422, the first elastomer layer 411, and the first electrode layer 412 are stacked in this order. In the figure, the X axis is an axis parallel to a direction in which a laminate is rolled, as described above. A Z axis is an axis vertical to the X axis and the Y axis.

As illustrated in FIG. 20A, an external shape of the laminate 430 has a side portion S41 and a side portion S42. Neither the first electrode layer 412 nor the second electrode layer 422 is exposed from the side portion S41. Further, neither the first electrode layer 412 nor the second electrode layer 422 is exposed from the side portion S42.

Here, the pattern (also referred to as a printing pattern or an application pattern) of the first electrode layer 412 is different from the pattern of the second electrode layer 422.

The difference in pattern between electrode layers is described below with reference to (b) of FIG. 20A and FIG. 20C.

When side portions of the two electrode layers that are situated on the side of a non-stepped bottom surface coincide, the difference in pattern between the two electrode layers can be considered a difference regarding the width of an electrode layer in the axial direction Y. As illustrated in, for example, (b) of FIG. 20A, the width of the first electrode layer 412 in the axial direction Y includes a region in which the width of the first electrode layer 412 in the axial direction Y is represented by W41, a region in which the width of the first electrode layer 412 in the axial direction Y is represented by W42, and a region in which the width of the first electrode layer 412 in the axial direction Y is represented by W43.

On the other hand, the second electrode layer 422 includes a region in which the width of the second electrode layer 422 in the axial direction Y is represented by W44, and a region in which the width of the second electrode layer 422 in the axial direction Y is represented by W45.

Here, W41 (and W43), W42, W44, and W45 have the following relationship: W42<W45<W41 (and W43)<W44. W41 may have the same value as W43, or W41 and W43 have different values. The first electrode layer and the second electrode layer are formed such that there is such a relationship. This makes it easy to form, in a stepped bottom surface of a rolled body, one step from which only one electrode layer is exposed. This also makes it easy to form, in the stepped bottom surface, a step from which neither of the electrode layers is exposed.

Alternatively, the difference in pattern between the two electrode layers may be considered a difference regarding a position of a side portion of each electrode layer in the Y-axis direction, where the side portion is parallel to the X-axis direction (in particular, the side portion is a side portion on the side of a stepped bottom surface).

As illustrated in, for example, FIG. 20C, the first electrode layer 412 has a shape that has two side portions at a position Y41 in the axial direction Y and a side portion at −Y42 when the first electrode layer 412 is incorporated into the laminate 330.

On the other hand, the second electrode layer 422 has a shape that has a side portion at a position Y43 in the axial direction Y and a side portion at a position Y44 in the axial direction when the second electrode layer 422 is incorporated into the laminate 430.

Here, Y41, Y42, Y43, and Y44 have the following relationship when a position of a side portion of an external shape of the laminate 430 is represented by Y40, the side portion being one of two side portions of the external shape that forms a stepped bottom surface, each of the two side portions being parallel to a rolling direction X: (distance between Y42 and Y40)>(distance between Y44 and Y40)>(distance between Y41 and Y40)>(distance between Y43 and Y40). The first electrode layer and the second electrode layer are formed such that there is such a relationship. This makes it easy to form, in a stepped bottom surface of a rolled body, one step from which only one electrode layer is exposed. This also makes it easy to form, in the stepped bottom surface, a step from which neither of the electrode layers is exposed.

Next, the external shape of the laminate 430 is adjusted, as illustrated in FIG. 20D. Specifically, the adjustment of the external shape is performed such that a stepped bottom surface is formed when a laminate 430′ obtained by the adjustment of the external shape is rolled. More specifically, the laminate 430 is cut along a dot-dash cutting line E-E′ illustrated in (b) of the figure. This results in partially cutting the side portion S42 of the laminate 430 to form side portions S43, S44, and S45, as illustrated in (c) of the figure.

Due to the cutting, the second electrode layer 422 is exposed from a cross-sectional surface including the side portion S43, neither of the electrode layers is exposed from a cross-sectional surface including the side portion S44, and the first electrode layer 412 is exposed from a cross-sectional surface including the side portion S45.

As described above, the laminate 430 is partially cut to form the side portions S43, S44, and S45. The second electrode layer 422 and the first electrode layer 412 are respectively exposed from the cross-sectional surface including the side portion S43 and the cross-sectional surface including the side portion S45, and further, the cross-sectional surface including the side portion S45 and from which neither of the electrode layers is exposed, is formed.

After the external shape is adjusted, the laminate 430′ is rolled in the rolling direction X, as illustrated in (c) of FIG. 20E, to obtain a rolled body. The rolling may be performed using a core, as described above. Note that the laminate 430′ may be rolled without using a core.

After the core is removed, a rolled body 440 as illustrated in (d) of the figure is obtained. In the figure, (d1) is a schematic perspective view illustrating a form of a non-stepped bottom surface of the rolled body 440. (d2) schematically illustrates a cross section of the rolled body 440 along a plane parallel to the rolling axis. (d3) is a schematic perspective view illustrating a form of a stepped bottom surface of the rolled body 440.

The rolled body 440 includes two bottom surfaces B41 and B42.

The bottom surface B41 may be formed of a lamination cross-sectional surface that includes the side portion S41. The bottom surface B41 is formed of the first and second elastomer layers 411 and 421. Neither of the electrode layers has to be exposed from the bottom surface B41.

A center portion of the bottom surface B41 corresponds to the hollow portion H created by removing the core.

Note that the bottom surface B41 may be a bottom surface formed by cutting performed in the cutting step described above. In this case, the cutting may be performed such that neither of the electrode layers is exposed from the bottom surface B41.

In the present disclosure, a non-stepped bottom surface of a rolled body may be formed of a lamination cross-sectional surface of at least one dielectric elastomer layer used to form the rolled body, as described above.

The bottom surface B42 is a stepped bottom surface and includes the steps T43, T44, and T45, where the step T43 is formed of the cross-sectional surface including the side portion S43, the step T44 is formed of the cross-sectional surface including the side portion S44, and the step T45 is formed of the cross-sectional surface including the side portion S45. As illustrated in (d2) and (d3) in the figure, the step T44 is recessed with respect to the steps T43 and T45. Further, the steps T43, T44, and T45 are formed concentrically about an axis of the rolled body, where the step T43 is situated on an outer peripheral side of the rolled body, the step T45 is situated on an inner-diameter side of the rolled body, and the step T44 is situated midway between the other two steps.

Furthermore, a center portion of the bottom surface B42 corresponds to the hollow portion H created by removing the core.

As described above, the rolled body according to the present disclosure may include, in one stepped bottom surface of the rolled body, three steps that are an inner-diameter-side step, an outer-peripheral-side step, and a midway step situated between the two steps. The midway step may be recessed with respect to the inner-diameter-side step and the outer-peripheral-side step.

The second electrode layer 422 is exposed from the step T43. More specifically, in addition to the first and second elastomer layers 411 and 421, the second electrode layer 422 is exposed from the step T43.

Note that, in (d2) and (d3) in the figure, the entirety of the surface of the step T43 is indicated by dots. However, actually, the first and second elastomer layers 411 and 421 are exposed from the step T43, and further, the second electrode layer 422 much thinner than each of the elastomer layers is situated between the elastomer layers to be exposed from the surface of the step T43, as described in the first example above.

Neither of the first and second electrode layers 412 and 422 is exposed from the step T44. More specifically, only the first and second elastomer layers 411 and 421 are exposed from the step T44, whereas neither of the electrode layers is exposed from the step T44.

The first electrode layer 412 is exposed from the step T45. More specifically, in addition to the first and second elastomer layers 411 and 421, the second electrode layer 422 is exposed from the step T45.

Note that, in (d2) and (d3) in the figure, the entirety of the surface of the step T45 is indicated by dots. However, actually, the first and second elastomer layers 411 and 421 are exposed from the step T45, and further, the first electrode layer 412 much thinner than each of the elastomer layers is situated between the elastomer layers to be exposed from the surface of the step T45, as described in the first example above.

Further, the step T44 is recessed with respect to the steps T43 and T45, as described above, and further, neither of the electrode layers is exposed from the step T44. This makes it possible to prevent a short circuit from being caused between the second electrode layer 422 exposed from the step T43 and the first electrode layer 412 exposed from the step T45.

In the present disclosure, no electrodes may be exposed from a midway step, as described above.

Further, a cap portion (not illustrated) may also be fitted into a stepped bottom surface B42 in this embodiment. The form of a stepped bottom surface is helpful in more strongly coupling the rolled body to the cap portion.

Further, an electrode may be provided to the cap portion. The electrode may be configured to electrically connect a circuit included in an rDEA to the second and first electrode layers respectively exposed from the steps T43 and T45.

### 1.4.5 Fifth Example (Rolled Body Including Two Stepped Bottom Surfaces and Method for Manufacturing Rolled Body)

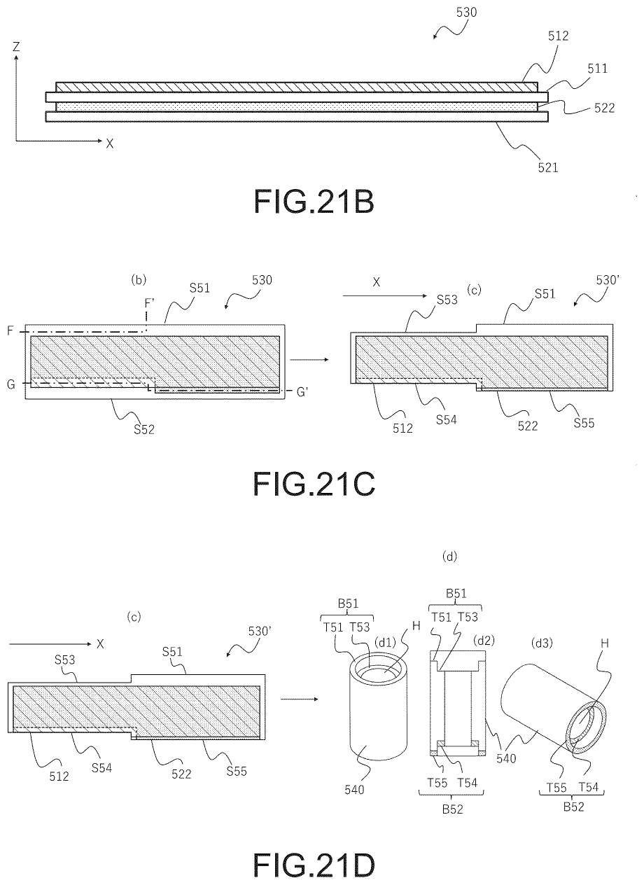

One of the two bottom surfaces of the rolled body described in the first to fourth examples above is a stepped bottom surface, and another of the two bottom surfaces is not a stepped bottom surface. In the present disclosure, both of the two bottom surfaces may be stepped bottom surfaces. A rolled body including stepped bottom surfaces and a method for manufacturing the rolled body are described below with reference to FIGS. 21A to 21D.

As illustrated in (a) of FIG. 21A, a first laminate 510 is provided that includes a first elastomer layer 511 and a first electrode layer 512 stacked on the first elastomer layer.

Further, a second laminate 520 is provided that includes a second elastomer layer 521 and a second electrode layer 522 stacked on the second elastomer layer.

More specifically, the first electrode layer 512 and the second electrode layer 522 are patterned to be respectively exposed from different steps of a stepped bottom surface of a rolled body described later. The patterns of the electrode layers are the same as the patterns described in the first example above, and the description of the patterns in the first example above also applies to this example. The patterns of the electrode layers may be other patterns.

The first laminate 510 is stacked on the second laminate 520 to obtain a laminate 530 illustrated in (b) of the figure.

In the figure, an X axis is an axis parallel to a direction in which a laminate described later is rolled. A Y axis is an axis parallel to an axis of a rolled body.

FIG. 21B schematically illustrates a cross section of the laminate 530. As illustrated in the figure, the laminate 530 has a lamination structure in which the second elastomer layer 521, the second electrode layer 522, the first elastomer layer 511, and the first electrode layer 512 are stacked in this order. In the figure, the X axis is an axis parallel to a direction in which a laminate is rolled, as described above. A Z axis is an axis vertical to the X axis and the Y axis.

As illustrated in FIG. 21A, an external shape of the laminate 530 has side portions S51 and S52 each substantially parallel to the rolling direction X. Neither the first electrode layer 512 nor the second electrode layer 522 is exposed from the side portion S51. Further, neither the first electrode layer 512 nor the second electrode layer 522 is exposed from the side portion S52.

Next, the external shape of the laminate 530 is adjusted, as illustrated in FIG. 21C. Specifically, the adjustment of the external shape is performed such that a stepped bottom surface is formed when a laminate 530′ obtained by the adjustment of the external shape is rolled. The following are how the adjustment of the external shape is performed.

The laminate 530 is cut along a dot-dash cutting line F-F′ illustrated in (b) of the figure. This results in partially cutting the side portion S51 of the laminate 530 to form a side portion S53, as illustrated in (c) of the figure. The side portion S53 may be substantially parallel to the X axis.

Further, the laminate 530 is cut along a dot-dash cutting line G-G′ illustrated in (b) of the figure. This results in partially cutting the side portion S52 of the laminate 530 to form side portions S54 and S55, as illustrated in (c) of the figure. Each of the side portions S54 and S55 may be substantially parallel to the X axis.

Due to the cutting, the first electrode layer 512 is exposed from a cross-sectional surface including the side portion S54, and the second electrode layer 522 is exposed from a cross-sectional surface including the side portion S55.

As described above, the two side portions being included in the laminate 530 and each being substantially parallel to the rolling direction are cut to form the side portions S53, S54, and S55. Neither of the electrode layers is exposed from a cross-sectional surface including the side portion S53 from among the formed side portions. On the other hand, the first electrode layer 512 and the second electrode layer 522 are respectively exposed from the cross-sectional surface including the side portion S54 and the cross section including the side portion S55.

After the external shape is adjusted, a laminate 530′ is rolled in the rolling direction X, as illustrated in (c) of FIG. 21D, to obtain a rolled body. The rolling may be performed using a core, as described above. Note that the laminate 530′ may be rolled without using a core.

After the core is removed, a rolled body 540 as illustrated in (d) of the figure is obtained. In the figure, (d1) is a schematic perspective view illustrating a form of a stepped bottom surface from between the two bottom surfaces of the rolled body 540, where the stepped bottom surface includes a bottom surface formed of the cross-sectional surface including the side portion S53, and a bottom surface formed of a lamination cross-sectional surface including the side portion S51. (d2) schematically illustrates a cross section of the rolled body 540 along a plane parallel to the rolling axis. (d3) is a schematic perspective view illustrating a form of a stepped bottom surface from between the two bottom surfaces of the rolled body 540, where the stepped bottom surface includes two bottom surfaces and electrode layers are respectively exposed from the two bottom surfaces.

As schematically illustrated, the rolled body 540 includes stepped bottom surfaces B51 and B52.

The bottom surface B51 is a stepped bottom surface and includes steps T51 and T53, where the step T51 is formed of the lamination cross-sectional surface including the side portion S51 and the step T53 is formed of the cross-sectional surface including the side portion S53. The steps T51 and T53 are each formed of the first and second elastomer layers 511 and 521, and neither of the electrode layers is exposed from each of these steps.

A center portion of the bottom surface B51 corresponds to the hollow portion H created by removing the core.

Further, the bottom surface B51 has a stepped structure, and the stepped structure may be used to fit a cap portion (not illustrated) into the bottom surface B51. The form of a stepped bottom surface is helpful in more strongly coupling the rolled body to the cap portion.

The bottom surface B52 is a stepped bottom surface and includes steps T54 and T55, where the step T54 is formed of the cross-sectional surface including the side portion S54 and the step T55 is formed of the cross-sectional surface including the side portion S55. As illustrated in (d2) and (d3) in the figure, the step T55 protrudes with respect to the step T54. Further, a center portion of the bottom surface B12 corresponds to the hollow portion H created by removing the core.

The first electrode layer 512 is exposed from the step T54. More specifically, in addition to the first and second elastomer layers 511 and 521, the first electrode layer 512 is exposed from the step T54.

Note that, in (d2) and (d3) in the figure, the entirety of the surface of the step T54 is hatched. However, actually, the first and second elastomer layers 511 and 521 are exposed from the step T54, and further, the first electrode layer 512 much thinner than each of the elastomer layers is situated between the elastomer layers to be exposed from the step T54, as described in the first example above.

The second electrode layer 522 is exposed from the step T55. More specifically, in addition to the first and second elastomer layers 511 and 521, the second electrode layer 522 is exposed from the step T55.

Note that, in (d2) and (d3) in the figure, the entirety of the surface of the step T55 is indicated by dots. However, actually, the first and second elastomer layers 511 and 521 are exposed from the step T55, and further, the second electrode layer 522 much thinner than each of the elastomer layers is situated between the elastomer layers to be exposed from the surface of the step T55, as described in the first example above.

Further, the step T55 protrudes with respect to the step T54, as described above. This makes it possible to prevent a short circuit from being caused between the first electrode layer 512 exposed from the step T54 and the second electrode layer 522 exposed from the step T55.

Further, as in the case of the bottom surface B51, the bottom surface B52 has a stepped structure, and the stepped structure may be used to fit a cap portion (not illustrated) into the bottom surface B52. The form of a stepped bottom surface is helpful in more strongly coupling the rolled body to the cap portion.

Furthermore, an electrode may be provided to the cap portion. The electrode may be configured to electrically connect a circuit included in an rDEA to the first and second electrode layers respectively exposed from the steps T54 and T55.

### 1.4.6 Sixth Example (Rolled Body Including Pattern Electrodes and Method for Manufacturing Rolled Body)

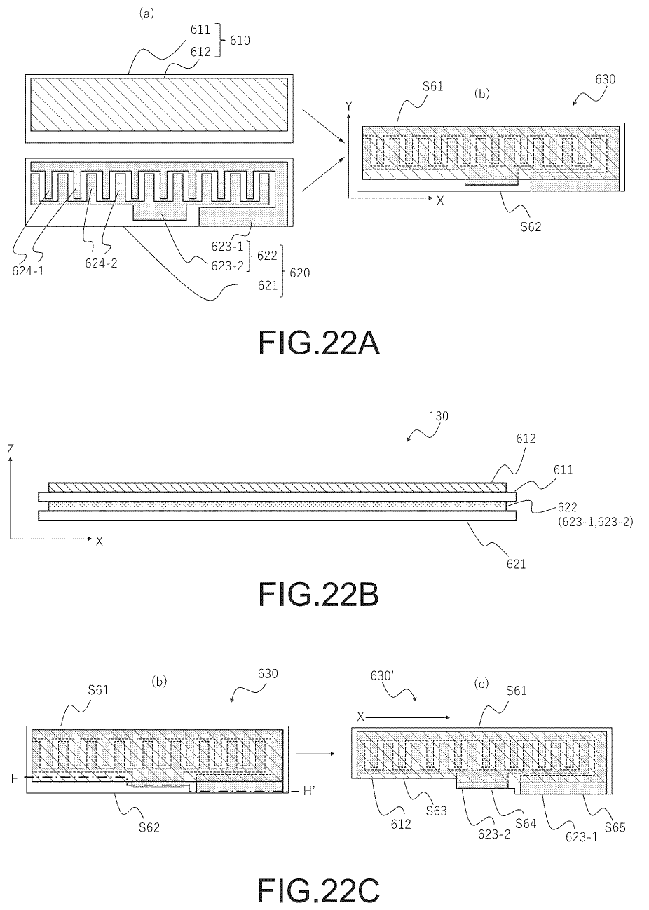

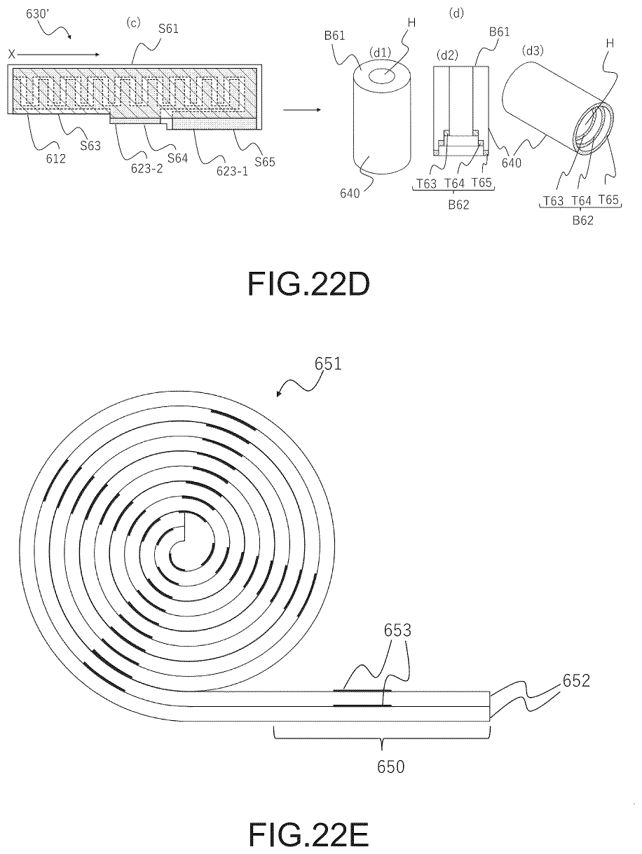

In the first to sixth examples above, one electrode layer includes one electrode. In an embodiment of the present disclosure, one electrode layer may include at least two electrodes. The at least two electrodes do not necessarily have to be electrically connected to each other. The at least two electrodes may be formed in one layer such that a specified pattern is formed. When one layer includes at least two electrodes, the control on application of voltage to the at least two electrodes makes it possible to not only cause an rDEA to extend and shrink in a direction of an axis of a rolled body but also bend the rolled body (especially bend the rolled body such that a portion corresponding to the axis is bent). This embodiment is described below with reference to FIGS. 22A to 22E.

As illustrated in (a) of FIG. 22A, a first laminate 610 is provided that includes a first elastomer layer 611 and a first electrode layer 612 stacked on the first elastomer layer.

Further, a second laminate 620 is provided that includes a second elastomer layer 621 and a second electrode layer 622 stacked on the second elastomer layer. The second electrode layer 622 includes first and second electrodes 623-1 and 623-2, where the two electrodes are formed in one layer such that a specified pattern is formed, as illustrated in the figure. With respect to the pattern, a pattern in the form of comb teeth is formed in each electrode in the figure. Further, the electrodes are provided such that a plurality of teeth 64-1 of a comb shape of the first electrode 623-1 and a plurality of teeth 624-2 of a comb shape of the second electrode 623-2 fit each other. Such a pattern enables a rolled body to include, after rolling, a circumferential portion that includes the first electrode but does not include the second electrode and a circumferential portion that does not include the first electrode but includes the second electrode. Furthermore, the control on application of voltage to the first and second electrodes makes it possible to bend the rolled body.

Note that the first electrode layer 612 includes one electrode in the figure, but this electrode layer may include at least two electrodes.

Next, the first laminate 610 is stacked on the second laminate 620, as illustrated in (b) of the figure. Accordingly, a laminate 630 obtained by stacking the second elastomer layer 621, the second electrode layer 622, the first elastomer layer 611, and the first electrode layer 612 in this order is formed, as illustrated in FIG. 22B. Note that patterns of the two electrodes included in the second electrode layer 622 are not illustrated in the figure.

As illustrated in FIG. 22A, an external shape of the laminate 630 has side portions S61 and S62. Neither the first electrode layer 612 nor the second electrode layer 622 is exposed from the side portion S61. Further, the first electrode layer 612 is not exposed from the side portion S62. The first electrode 623-1 included in the second electrode layer 622 is exposed from the side portion S62, whereas the second electrode 623-2 included in the second electrode layer 622 is not exposed from the side portion S62.

Next, the external shape of the laminate 630 is adjusted, as illustrated in FIG. 22C. Specifically, the adjustment of the external shape is performed such that a stepped bottom surface is formed when a laminate 630′ obtained by the adjustment of the external shape is rolled. More specifically, the laminate 630 is cut along a dot-dash cutting line H-H′ illustrated in (b) of the figure. This results in partially cutting the side portion S62 of the laminate 630 to form side portions S63, S64, and S65, as illustrated in (c) of the figure. Due to the cutting, the first electrode layer 612 is exposed from a cross-sectional surface including the side portion S63, the second electrode 623-2 included in the second electrode layer 622 is exposed from a cross-sectional surface including the side portion S64, and the first electrode 623-1 included in the second electrode layer 622 is exposed from a cross-sectional surface including the side portion S65.

As described above, the laminate 130 is partially cut to form the side portions S63, S64, and S65, and one electrode is exposed from each of the cross-sectional surfaces including the respective side portions.

After the external shape is adjusted, the laminate 630′ obtained by the adjustment of the external shape is rolled in the rolling direction X, as illustrated in (c) of FIG. 22D, to obtain a rolled body. The rolling may be performed using a core, as described above. Note that the laminate 630′ may be rolled without using a core.

After the core is removed, a rolled body 640 as illustrated in (d) of the figure is obtained. In the figure, (d1) is a schematic perspective view illustrating a form of a non-stepped bottom surface of the rolled body 640. (d2) schematically illustrates a cross section of the rolled body 640 along a plane parallel to the rolling axis. (d3) is a schematic perspective view illustrating a form of a stepped bottom surface of the rolled body 640.

The rolled body 640 includes two bottom surfaces B61 and B62.

The bottom surface B61 may be formed of a lamination cross-sectional surface that includes the side portion S61. The bottom surface B61 is formed of the first and second elastomer layers 611 and 621. Neither of the electrode layers has to be exposed from the bottom surface B61.

A center portion of the bottom surface B61 corresponds to the hollow portion H created by removing the core.

The bottom surface B62 is a stepped bottom surface and includes steps T63, T64, and T65, where the step T63 is formed of the cross-sectional surface including the side portion S63, the step T64 is formed of the cross-sectional surface including the side portion S64, and the step T65 is formed of the cross-sectional surface including the side portion S65. As illustrated in (d2) and (d3) in the figure, the steps T65, T64, and T63 are gradually recessed in this order. A center portion of the bottom surface B62 corresponds to the hollow portion H created by removing the core.

As described above, the rolled body according to the present disclosure includes, in one stepped bottom surface of the rolled body, three steps that are an inner-diameter-side step, an outer-peripheral-side step, and a midway step situated between the two steps, and the rolled body may be configured such that the midway step protrudes with respect to the inner-diameter-side step and is recessed with respect to the outer-peripheral-side step.

Further, when the rolling is performed in the opposite direction, this may result in the rolled body being configured such that the midway step is recessed with respect to the inner-diameter-side step and protrudes with respect to the outer-peripheral-side step.

The first electrode layer 612 is exposed from the step T63. More specifically, in addition to the first and second elastomer layers 611 and 621, the first electrode layer 612 is exposed from the step T63.

Note that, in (d2) and (d3) in the figure, the entirety of the surface of the step T63 is hatched. However, actually, the first and second elastomer layers 611 and 621 are exposed from the step T63, and further, the first electrode layer 612 much thinner than each of the elastomer layers is situated between the elastomer layers to be exposed from the step T63, as described in the first example above.

The second electrode 623-2 included in the second electrode layer 622 is exposed from the step T64. More specifically, in addition to the first and second elastomer layers 611 and 621, the second electrode 623-2 is exposed from the step T64.

Note that, in (d2) and (d3) in the figure, the entirety of the surface of the step T64 is indicated by dots. However, actually, the first and second elastomer layers 611 and 621 are exposed from the step T64, and further, the second electrode 623-2 much thinner than each of the elastomer layers is situated between the elastomer layers to be exposed from the step T64, as described in the first example above.

The first electrode 623-1 included in the second electrode layer 622 is exposed from the step T65. More specifically, in addition to the first and second elastomer layers 611 and 621, the first electrode 623-1 is exposed from the step T65.

Note that, in (d2) and (d3) in the figure, the entirety of the surface of the step T65 is indicated by dots. However, actually, the first and second elastomer layers 611 and 621 are exposed from the step T65, and further, the first electrode 623-1 much thinner than each of the elastomer layers is situated between the elastomer layers to be exposed from the step T65, as described in the first example above.

Further, the step T65 protrudes with respect to the step T64 and the step T64 protrudes with respect to the T63, as described above. This makes it possible to prevent short circuits from being caused between the electrodes respectively exposed from these three steps.

In other words, the steps T63, T64, and T65 are situated at different positions in a direction of the axis of a rolled body, and this makes it possible to prevent short circuits from being caused between the electrodes respectively exposed from the steps.

Further, voltage can be applied in various patterns in this embodiment. For example, one of a voltage application pattern in which voltage is applied between the first electrode layer 612 and the first electrode 623-1, a voltage application pattern in which voltage is applied between the first electrode layer 612 and the second electrode 623-2, and a voltage application pattern in which voltage is applied between the first electrode layer 612 and the first electrode 623-1 and between the first electrode layer 612 and the second electrode 623-2, can be adopted. Each voltage application pattern results in an rDEA (especially a rolled body) being bent, or in the rDEA extending and shrinking.

For example, the voltage application pattern in which voltage is applied between the first electrode layer 612 and the first electrode 623-1 and between the first electrode layer 612 and the second electrode 623-2 may result in an rDEA extending and shrinking. Further, the voltage application pattern in which voltage is applied between the first electrode layer 612 and the first electrode 623-1, and the voltage application pattern in which voltage is applied between the first electrode layer 612 and the second electrode 623-2 may each result in an rDEA being bent.

As described above, a dielectric elastomer actuator according to the present disclosure may be configured such that voltage can be applied to at least two electrically unconnected electrodes in an independent manner.

The bend of an rDEA is further described with reference to FIG. 22E. The figure is a schematic cross-sectional view illustrating a state in which a rolled body 651 is formed by rolling a laminate 650 including a patterned electrode layer and a dielectric elastomer layer, where the cross section is a cross section vertical to an axis of the rolled body. The laminate 650 includes a dielectric elastomer layer 652 and a patterned electrode layer 653 on the dielectric elastomer layer 652. The rolled body 651 is obtained by rolling the laminate 650 including the patterned electrode layer. As illustrated in the figure, the rolled body 651 only includes the electrode layer 653 in a specific portion (four portions in the figure) of a cross section of a column. When voltage is applied in a specified pattern to the electrode layer 653 formed as described above, this enables an rDEA including the rolled body 651 to perform various movements such as extension and shrinkage, and a bend in a specified direction.

1.5 Method for Manufacturing rDEA According to Present Disclosure

The present disclosure also provides a method for manufacturing an rDEA. The manufacturing method may include a stacking step to form a laminate in which an electrode layer and an elastomer layer are stacked alternately, an external shape adjusting step to adjust an external shape of the laminate, and a rolled body forming step to form a rolled body by rolling the laminate of which the external shape has been adjusted. Here, the external shape adjusting step may be performed such that the rolled body includes at least one stepped bottom surface. An rDEA that includes a stepped bottom surface is manufactured by performing the external shape adjusting step.

The manufacturing method according to the present disclosure may be performed as described in, for example, 1.3 above, and the description in 1.3 above also applies to the manufacturing method according to the present disclosure.

For example, the stacking step and the external shape adjusting step may be performed as described in 1.3.1 above, and in particular, they may be performed as described in 1.3.1 above with respect to the stacking step S13 and the external shape adjusting step S14.

Further, the rolled body forming step may be performed as described in 1.3.2 above.

### 2. Second Embodiment (Transducer)

The present disclosure also provides a transducer that includes the above-described rolled body including a stepped bottom surface. The transducer may include the rolled body and a circuit that is electrically connected to the rolled body (especially to an electrode layer). The transducer may be configured to sense a distortion in rolled body. The circuit may be, for example, a capacitance detection circuit, in order to perform the sensing. The capacitance detection circuit may be configured to detect capacitance between complimentary electrode layers. The capacitance is changed according to a distortion in the rolled body. Thus, the detection of the capacitance makes it possible to detect a distortion in the rolled body.

When, for example, a rolled body extends, a dielectric elastomer between electrode layers is made thinner, and this results in an increase in the area covered by the electrode layers. This increase in the area results in an increase in capacitance. When, conversely, the rolled body extends and shrinks, the dielectric elastomer between the electrode layers is made thicker, and this results in a reduction in the area covered by the electrode layers. This reduction in the area results in a reduction in capacitance. In other words, these electrode layers are considered a variable capacitor.

Thus, when the rolled body according to the present disclosure includes a pair of electrodes used to measure a change (that is, an increase or a reduction) in capacitance, this makes it possible to detect a deformation of the rolled body or to quantify a degree of the deformation of the rolled body.

The pair of electrodes used to detect the change in capacitance may be electrically connected to the electrode layers described above. In other words, electrodes included in the pair of electrodes may be respectively electrically connected to two electrode layers between which a dielectric elastomer layer is situated. Further, the pair of electrodes may be electrically connected to a specified capacitance detection circuit. In other words, in addition to the rolled body, the transducer may include a capacitance detection circuit connected to electrode layers included in the rolled body. The circuit may be connected to the electrode layers of the rolled body through the pair of electrodes.

Further, the transducer may operate to sense a distortion in rolled body, or may operate as a dielectric elastomer actuator, or may include both of the functions.

### 3. Third Embodiment (Apparatus or System)

The present disclosure provides an apparatus that includes an rDEA or transducer according to the present disclosure. The apparatus may be, for example, an operation input apparatus or an endoscope apparatus. Further, the present disclosure also provides an information processing system that includes the rDEA or the transducer. The rDEA or the transducer can be used in various apparatuses and systems. The rDEA or the transducer is small, and can also prevent an issue regarding a short circuit from being caused.

The apparatus may be an operation input apparatus. The operation input apparatus includes, for example, a movable member that is moved by operation performed by a user, and an rDEA that controls movability of the movable member. The rDEA may be an rDEA according to the present disclosure.

The rDEA may control the movability to adjust a feeling of resistance to movement of the movable member. This enables a user who is operating the operation input apparatus (especially the movable member) to perceive various kinds of feelings of resistance upon the operation, that is, this makes it possible to provide various kinds of feelings (such as a sense of touch) to the user. For example, an interesting or exciting experience can be provided to the user.

The operation input apparatus may be an operation input apparatus of, for example, a button type, a wheel type, a ball type, or a joystick type, but is not limited thereto. Examples of these types will be described below. Further, the operation input apparatus according to the present disclosure may be used as, for example, a haptic device since the operation input apparatus can provide various kinds of feelings to the user.

The operation input apparatus may include a movable member that is moved by operation performed by a user, and a transducer that senses the user operation performed on the movable member. The transducer may be a transducer according to the present disclosure.

For example, the operation input apparatus according to the present disclosure may be, for example, a controller of a game machine, or an element (such as a button unit) included in a controller of a game machine. The present disclosure makes it possible to control movability of a movable member quietly at high speed. In addition, the number of parts necessary to control movability of a movable member according to the present disclosure is small. Thus, the apparatus can be made smaller in size and lighter in weight. Further, a configuration of the apparatus can be made simpler. These advantages are provided significantly especially when the present disclosure is applied to a controller of a game machine.

### 3.1 Example of Configuration of Apparatus (Button)

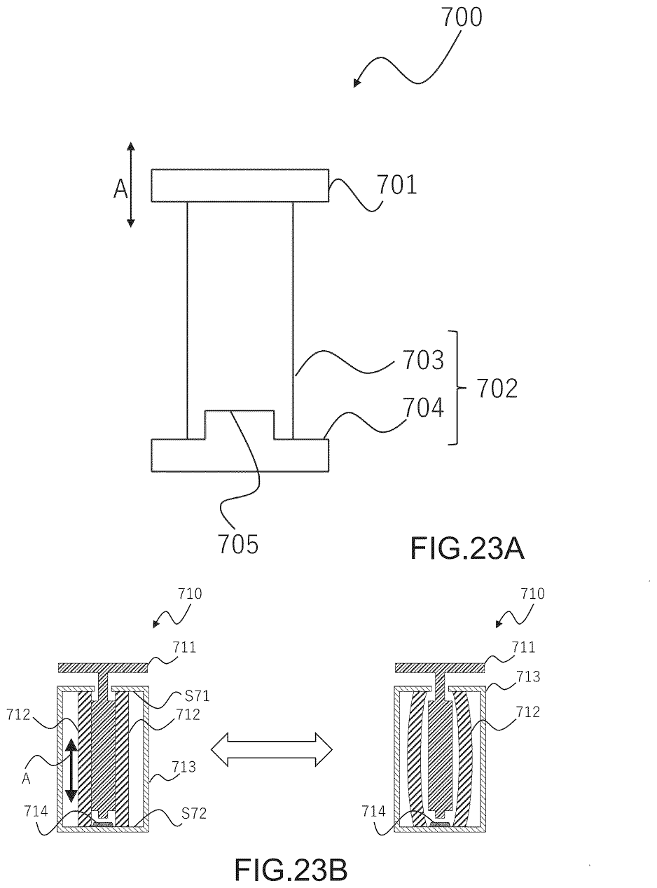

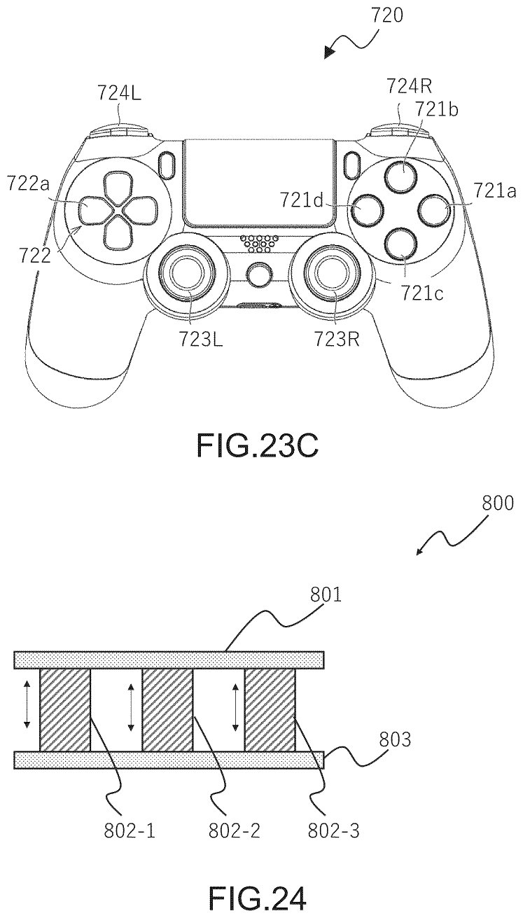

Examples of the operation input apparatus according to the present disclosure are described below with reference to FIGS. 23A to 23C.

As illustrated in, for example, FIG. 23A, an operation input apparatus 700 according to the present disclosure may include a movable member 701 that receives input of a user operation, and an rDEA 702 that controls movability of the movable member. The rDEA is an rDEA according to the present disclosure, and may especially include a rolled body 703 including a stepped bottom surface 705, and a cap portion 704 that is fitted into the stepped bottom surface of the rolled body. The cap portion 704 is provided with an electrode to which a complimentary electrode layer (especially a complimentary electrode layer exposed from the stepped bottom surface) included in the rolled body is electrically connected, and the electrode is connected to a circuit.

The movable member 701 can move in a direction of an arrow A in the figure, and may serve as, for example, a button pressed by a user. The rDEA may control movability of the button.

Another example of an operation input apparatus is described with reference to FIG. 23B.

On the left in the figure, there is a schematic cross-sectional diagram of an operation input apparatus 710 according to the present disclosure. The operation input apparatus 710 includes a movable member 711 that receives a user operation, and an rDEA 712 that controls movability of the movable member. The operation input apparatus further includes a housing 713 that accommodates therein the rDEA 712, and a movement detection sensor 714 that detects movement of the movable member 711. Those structural elements are described below.

The rDEA 712 is configured to control the movability of the movable member 711 using a change in an inner diameter of a cylindrical form of the rDEA 712. The movable member 711 is arranged in a hollow portion of the rDEA 712.

The rDEA 712 is fixed to two inner surfaces S71 and S72 situated inside of the housing 713. The rDEA 712 is configured to extend in a direction of an arrow A in the figure (a direction of an axis of the cylinder) due to voltage being applied to the rDEA 712.

On the left in the figure, voltage is not applied to the rDEA 712. In this case, the rDEA 712 is in contact with the movable member 711.

The rDEA 712 extends in the direction of the arrow A in the figure due to voltage being applied to the rDEA 712. However, a distance between the inner surfaces S1 and S2 is constant, and the DEA 752 is fixed to the inner surfaces S71 and S72. Thus, there is a change in the inner diameter of the rDEA 712, as illustrated on the right in the figure. In other words, the inner diameter of the rDEA 712 is increased due to the application of voltage, and this results in the rDEA 712 becoming out of contact with the movable member 751 (or this results in a reduction in a pressure of contact of the rDEA 712 with the movable member 711). As a result, no friction is caused between the movable member 711 and the rDEA 712 (or there is a reduction in friction), and this results in a reduction in a feeling of resistance that is perceived upon operation of the movable member 711.

The operation input apparatus according to the present disclosure may be, for example, a controller used for a game machine. Examples of the controller include a controller having a configuration as illustrated in FIG. 23C. Four operational buttons 721a to 721d are provided to the controller 720. The rDEA according to the present disclosure may be used to control movability of the buttons. In other words, the rDEA according to the present disclosure may be configured to control movability of each button that is a movable member.

Further, the controller includes a D-pad 722, analog sticks 723R and 723L, and trigger buttons 724R and 724L, where the D-pad 722 includes four convex portions 722a that are movable members that each receive a user operation. The rDEA according to the present disclosure may be incorporated into the controller to control movability of the movable members.

3.2 Example of Configuration of Apparatus (Plurality of rDEAs)

The operation input apparatus according to the present disclosure may include one rDEA or a plurality of rDEAs. When, for example, the plurality of rDEAs is controlled in a separate manner, this makes it possible to produce various kinds of feelings. Further, the rDEA according to the present disclosure is small in size and light in weight. Thus, the plurality of rDEAs can be arranged in a small space, and further, the apparatus itself can be made lighter in weight. An example of an operation input apparatus including a plurality of rDEAs is described below with reference to FIG. 24.

The figure schematically illustrates where rDEAs are arranged in an operation input apparatus 800. The operation input apparatus includes a movable member 801, a plurality of rDEAs 802-1, 802-2, and 802-3, and a housing 803. Further, the operation input apparatus includes a sensor (not illustrated) that detects movement of the movable member 801.

The rDEAs 802-1 to 802-3 are configured to be capable of extending and shrinking independently of each other in directions of respective arrows illustrated in the figure. When the extensions and shrinkages of the rDEAs 802-1 to 802-3 are controlled in a separate manner, this makes it possible to variously change a feeling perceived by a user upon pressing the movable member 801.

When, for example, voltage is applied to one of or two of the three rDEAs and voltage is not applied to the other two of or the other one of the rDEAs, this makes it possible to change movability of the movable member 201 more variously, compared to when voltage is applied to all of the rDEAs or voltage is not applied to any of the rDEAs.

Further, the operation input apparatus 800 in the figure is configured such that three rDEAs control movability of one movable member. However, the number of rDEAs may be four or more.

Furthermore, in the operation input apparatus 800 in the figure, three rDEAs are arranged one-dimensionally. However, a plurality of rDEAs may be arranged two-dimensionally.

### 3.3 Example of Configuration of Apparatus (Endoscope Apparatus)

The present disclosure also provides an endoscope apparatus including the rDEA according to the present disclosure. For example, a tip camera portion of a videoscope included in the endoscope apparatus may include the rDEA according to the present disclosure. The rDEA may be configured to change a form of the tip camera portion. The rDEA according to the present disclosure is small in size and light in weight, and thus is suitable for being provided to the tip camera portion. For example, the rDEA may be configured such that the tip camera portion extends and shrinks, or the rDEA may be configured such that the tip camera portion is bent in a desired direction.

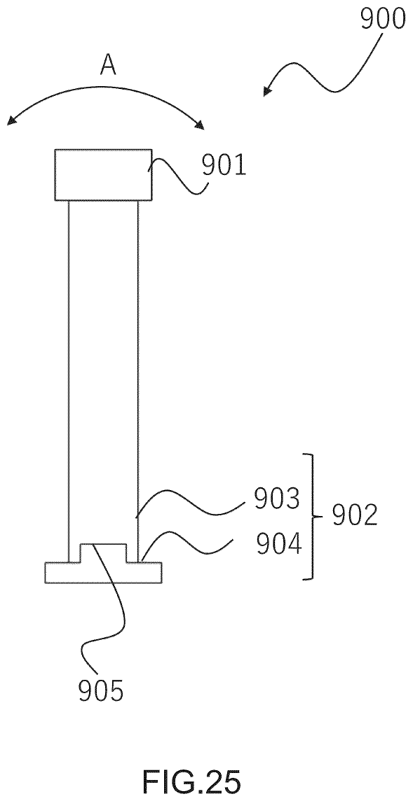

An example of a videoscope included in an endoscope apparatus is described with reference to FIG. 25.

A videoscope 900 for endoscope according to the present disclosure includes an image-capturing apparatus 901, and an rDEA 902 that is connected to the image-capturing apparatus and that controls an orientation of the image-capturing apparatus. The rDEA is an rDEA according to the present disclosure, and may especially include a rolled body 903 including a stepped bottom surface 905, and a cap portion 904 that is fitted into the stepped bottom surface of the rolled body. The cap portion 904 is provided with an electrode to which a complimentary electrode layer (especially a complimentary electrode layer exposed from the stepped bottom surface) included in the rolled body is electrically connected, and the electrode is connected to a circuit.

The rDEA 902 may be configured such that the image-capturing apparatus 901 can move in a direction of an arrow A in the figure. For example, the rDEA may be configured to be bendable, as described in the sixth example above. The rDEA is bent by, for example, an information processing apparatus in response to a user operating the endoscope apparatus. This makes it possible to change a position at which image-capturing is performed using the image-capturing apparatus 901.

### 3.4 Example of Configuration of Information Processing System

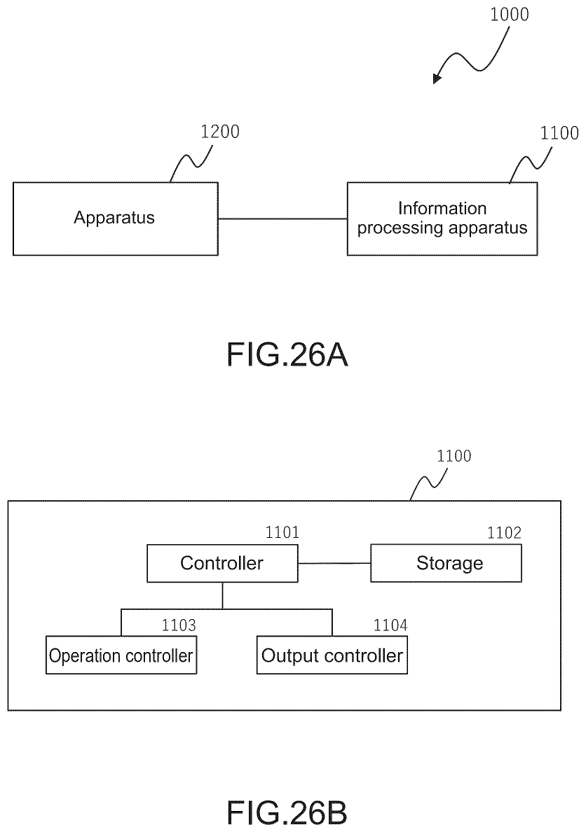

The present disclosure also provides an information processing system that includes the apparatus described above (such as the operation input apparatus or the endoscope apparatus). An example of the information processing system is described with reference to FIGS. 26A and 26B.

In an embodiment, an information processing system 1000 according to the present disclosure may include an information processing apparatus 1100 in addition to an apparatus (such as the operation input apparatus or the endoscope apparatus) 1200 according to the present disclosure, as illustrated in FIG. 26A, where the information processing apparatus 1100 is configured to transmit, to the apparatus 1200, a signal (an electric signal) used to control an rDEA. The information processing apparatus 1100 may control the apparatus 1200 such that a specified voltage is applied to the rDEA of the apparatus 1200.

In another embodiment, the information processing system 1000 according to the present disclosure may include the information processing apparatus 1100 in addition to the apparatus 1200 according to the present disclosure, where the information processing apparatus 1100 is configured to receive, from the apparatus 1200, a signal (an electric signal) related to deformation of a rolled body (a change in capacitance in particular). The information processing apparatus 1100 may perform specified information processing according to the signal received from the apparatus 1200.

Further, the information processing apparatus 1100 may be configured to receive a signal (an electric signal) generated by operation performed by a user on the apparatus 1200 (the operation input apparatus in particular).

The information processing apparatus 1100 and the apparatus 1200 may be connected to each other by any connection method, and may be connected to each other through, for example, a USB cable. A signal of which transmission or reception is performed between the information processing apparatus 1100 and the apparatus 1200 may be set as appropriate by those skilled in the art.

In an embodiment, the information processing apparatus 1100 may be, for example, an information processing apparatus that can execute a game, and may be what is called a game machine. In this case, the apparatus 1200 may be a controller of the game machine.

A configuration of the information processing apparatus 1100 may be set as appropriate by those skilled in the art, and the information processing apparatus 1100 may include, for example, a controller 1101, a storage 1102, an operation controller 1103, and an output controller 1104, as illustrated in FIG. 26B. Note that, for example, functions of the controller 1101, the operation controller 1103, and the output controller 1104 may be integrated into a single controller.

The controller 1101 may be a program control device such as a CPU and/or a GPU, and may operate in accordance with a program stored in the storage 1102. When, for example, the information processing apparatus 1100 is a game machine, the controller 1101 may be configured to execute an application of a game. When the controller 1101 receives, from the operation controller 1103, a signal input by operation performed by a user on the operation input apparatus 1200, the controller 1101 may perform specified processing on the basis of the signal.

The storage 1102 may be, for example, a memory device or a hard disk drive, and may store therein a program executed by the controller 1101.

The operation controller 1103 is connected to the operation input apparatus 1200 by a specified connection method (to be capable of communicating with the operation input apparatus 1200, for example, wirelessly or by wire). The operation controller 1103 receives, from the operation input apparatus 1200, a signal indicating details of operation performed by a user on the operation input apparatus 1200, and transmits the signal to the controller 1101.

The output controller 1104 may be connected to a display device of a television, a monitor, or a head-mounted display, and outputs a signal of sound and/or a video to the display device according to an instruction input by the controller 1101.

The present disclosure may take the following configurations.

[1] A rolled dielectric elastomer actuator, including
a rolled body of a laminate including at least one pair of complimentary electrode layers and a dielectric elastomer layer, the rolled body including at least one stepped bottom surface.
   [2] The dielectric elastomer actuator according to [1], in which
the rolled body includes at least first and second steps in one stepped bottom surface from among the at least one stepped bottom surface,
one of electrode layers of the at least one pair of complimentary electrode layers is exposed from the first step, and
another of the electrode layers of the at least one pair of complimentary electrode layers is exposed from the second step.
   [3] The dielectric elastomer actuator according to [1] or [2], in which
the rolled body includes at least first and second steps in one stepped bottom surface from among the at least one stepped bottom surface, and
the steps are arranged concentrically.
   [4] The dielectric elastomer actuator according to any one of [1] to [3], in which
the rolled body includes, in one stepped bottom surface from among the at least one stepped bottom surface, two steps that are an inner-diameter-side step and an outer-peripheral-side step, and
the rolled body has a structure in which the inner-diameter-side step is recessed or protrudes with respect to the outer-peripheral-side step.
   [5] The dielectric elastomer actuator according to any one of [1] to [4], in which
the rolled body includes, in one stepped bottom surface from among the at least one stepped bottom surface, three steps that are an inner-diameter-side step, an outer-peripheral-side step, and a midway step situated between the two steps, and
the midway step is recessed or protrudes with respect to the inner-diameter-side step and/or the outer-peripheral-side step.
   [6] The dielectric elastomer actuator according to [5], in which
no electrodes are exposed from the outer-peripheral-side step.
   [7] The dielectric elastomer actuator according to [5], in which
no electrodes are exposed from the midway step.
   [8] The dielectric elastomer actuator according to any one of [1] to [7], in which
two bottom surfaces of the rolled body are stepped bottom surfaces.
   [9] The dielectric elastomer actuator according to any one of [1] to [8], in which
at least one of electrode layers of the at least one pair of complimentary electrode layers includes at least two electrically unconnected electrodes.
   [10] The dielectric elastomer actuator according to [9], in which
the at least two electrically unconnected electrodes are respectively exposed from different steps of one stepped bottom surface from among the at least one stepped bottom surface.
   [11] The dielectric elastomer actuator according to [9] or [10], in which
the at least two electrically unconnected electrodes are formed in one of the electrode layers such that a specified pattern is formed.
   [12] The dielectric elastomer actuator according to any one of [9] to [11], in which
the dielectric elastomer actuator is configured to enable voltage to be applied to the at least two electrically unconnected electrodes in an independent manner.
   [13] The dielectric elastomer actuator according to any one of [1] to [12], in which
the dielectric elastomer actuator is configured to be extendable and shrinkable in a direction of an axis of the rolled body.
   [14] The dielectric elastomer actuator according to any one of [1] to [13], in which
the dielectric elastomer actuator is configured such that the rolled body is bendable.
   [15] The dielectric elastomer actuator according to any one of [1] to [14], further including
a cap portion that is fitted into the stepped bottom surface.
   [16] A transducer, including
a rolled body of a laminate including at least one pair of complimentary electrode layers and a dielectric elastomer layer, the rolled body including at least one stepped bottom surface.
   [17] An apparatus, including
the dielectric elastomer actuator according to claim 1.
   [18] The apparatus according to [17], in which
the apparatus is an operation input apparatus or an endoscope apparatus.
   [19] An information processing system, including
the apparatus according to [17] or [18].
   [20] A method for manufacturing a dielectric elastomer actuator, the method including:
a stacking step to form a laminate in which an electrode layer and an elastomer layer are stacked alternately;
an external shape adjusting step to adjust an external shape of the laminate; and
a rolled body forming step to form a rolled body by rolling the laminate of which the external shape has been adjusted,
the external shape adjusting step being performed such that the rolled body includes at least one stepped bottom surface.

The embodiments and examples of the present disclosure have been specifically described above. However, the present disclosure is not limited to the embodiments and examples described above, and various modifications based on technical ideas of the present disclosure may be made thereto.

For example, the configurations, the methods, the steps, the shapes/the forms, the materials, the numerical values, and the like in the embodiments and examples described above are merely illustrative, and a configuration, a method, a step, a shape/a form, a material, a numerical value, and the like that are different from those described above may be used as necessary. Further, the configurations, the methods, the steps, the shapes/the forms, the materials, the numerical values, and the like in the embodiments and examples described above may be combined without departing from the spirit of the present disclosure.

Further, as used herein, the numerical-value range shown using “-” indicates a range that includes, as a minimum value and a maximum value, respective numerical values placed before and after “-”. With respect to the gradually varying numerical-value range described herein, an upper limit of a certain numerical-value range may be replaced with an upper limit of another numerical-value range, or a lower limit of the certain numerical-value range may be replaced with a lower limit of the other numerical-value range.

### REFERENCE SIGNS LIST

10 laminate
11, 21 dielectric elastomer layer
12, 22 electrode layer
30 rolled body
31 cap portion

1. A rolled dielectric elastomer actuator, comprising
a rolled body of a laminate including at least one pair of complimentary electrode layers and a dielectric elastomer layer, the rolled body including at least one stepped bottom surface.

2. The dielectric elastomer actuator according to claim 1, wherein
the rolled body includes at least first and second steps in one stepped bottom surface from among the at least one stepped bottom surface,
one of electrode layers of the at least one pair of complimentary electrode layers is exposed from the first step, and
another of the electrode layers of the at least one pair of complimentary electrode layers is exposed from the second step.

3. The dielectric elastomer actuator according to claim 1, wherein
the rolled body includes at least first and second steps in one stepped bottom surface from among the at least one stepped bottom surface, and
the steps are arranged concentrically.

4. The dielectric elastomer actuator according to claim 1, wherein
the rolled body includes, in one stepped bottom surface from among the at least one stepped bottom surface, two steps that are an inner-diameter-side step and an outer-peripheral-side step, and
the rolled body has a structure in which the inner-diameter-side step is recessed or protrudes with respect to the outer-peripheral-side step.

5. The dielectric elastomer actuator according to claim 1, wherein
the rolled body includes, in one stepped bottom surface from among the at least one stepped bottom surface, three steps that are an inner-diameter-side step, an outer-peripheral-side step, and a midway step situated between the two steps, and
the midway step is recessed or protrudes with respect to the inner-diameter-side step and/or the outer-peripheral-side step.

6. The dielectric elastomer actuator according to claim 5, wherein
no electrodes are exposed from the outer-peripheral-side step.

7. The dielectric elastomer actuator according to claim 5, wherein
no electrodes are exposed from the midway step.

8. The dielectric elastomer actuator according to claim 1, wherein
two bottom surfaces of the rolled body are stepped bottom surfaces.

9. The dielectric elastomer actuator according to claim 1, wherein
at least one of electrode layers of the at least one pair of complimentary electrode layers includes at least two electrically unconnected electrodes.

10. The dielectric elastomer actuator according to claim 9, wherein
the at least two electrically unconnected electrodes are respectively exposed from different steps of one stepped bottom surface from among the at least one stepped bottom surface.

11. The dielectric elastomer actuator according to claim 9, wherein
the at least two electrically unconnected electrodes are formed in one of the electrode layers such that a specified pattern is formed.

12. The dielectric elastomer actuator according to claim 9, wherein
the dielectric elastomer actuator is configured to enable voltage to be applied to the at least two electrically unconnected electrodes in an independent manner.

13. The dielectric elastomer actuator according to claim 1, wherein
the dielectric elastomer actuator is configured to be extendable and shrinkable in a direction of an axis of the rolled body.

14. The dielectric elastomer actuator according to claim 1, wherein
the dielectric elastomer actuator is configured such that the rolled body is bendable.

15. The dielectric elastomer actuator according to claim 1, further comprising
a cap portion that is fitted into the stepped bottom surface.

16. A transducer, comprising
a rolled body of a laminate including at least one pair of complimentary electrode layers and a dielectric elastomer layer, the rolled body including at least one stepped bottom surface.

17. An apparatus, comprising
the dielectric elastomer actuator according to claim 1.

18. The apparatus according to claim 17, wherein
the apparatus is an operation input apparatus or an endoscope apparatus.

19. An information processing system, comprising
the apparatus according to claim 17.

20. A method for manufacturing a dielectric elastomer actuator, the method comprising:
a stacking step to form a laminate in which an electrode layer and an elastomer layer are stacked alternately;
an external shape adjusting step to adjust an external shape of the laminate; and
a rolled body forming step to form a rolled body by rolling the laminate of which the external shape has been adjusted,
the external shape adjusting step being performed such that the rolled body includes at least one stepped bottom surface.
